(19) United States
(12) Patent Application Publication
(10) Pub. No.: US 2018/0067780 A1
(43) Pub. Date: Mar. 8, 2018

(54) SERVER STORAGE SYSTEM MANAGEMENT SYSTEM AND MANAGEMENT METHOD

(71) Applicant: HITACHI, LTD., Tokyo (JP)

(72) Inventors: Mitsumasa NODA, Tokyo (JP); Tomohito UCHIDA, Tokyo (JP); Yoshifumi TAKAMOTO, Tokyo (JP); Shigeki ARATA, Tokyo (JP); Shinichi HAYASHI, Tokyo (JP); Takayuki NAGAI, Tokyo (JP)

(73) Assignee: HITACHI, LTD., Tokyo (JP)

(21) Appl. No.: 15/552,683

(22) PCT Filed: Jun. 30, 2015
(86) PCT No.: PCT/JP2015/068746

§ 371 Date: Aug. 22, 2017

(51) Int. Cl. G06F 9/50; G06F 9/455; H04L 12/24

(52) U.S. Cl. CPC G06F 9/5077; H04L 41/0806; G06F 9/45558; G06F 9/5083

(57) ABSTRACT

A server storage system comprises a plurality of server resources and a plurality of storage resources. A management system stores allocation control information. The allocation control information represents correspondences among resource types and resource quantities of exclusively allocated server resources and storage resources, resource types and resource quantities of commonly allocated server resources and storage resources, and virtual server load characteristics which are characteristics of virtual server loads. The management system accepts a virtual server creation instruction which is associated with one or more types of load characteristic information which is inputted by a manager and which relates to virtual server load characteristics, and on the basis of the allocation control information and the one or more types of load characteristic information, selects the exclusively allocated server resources and storage resources. The management system allocates the selected resources to a target virtual server. The allocation control information may be modified.

### TECHNICAL FIELD

The present invention generally relates to allocation of resources of a server storage system.

### BACKGROUND ART

There is a known server storage system including a server and a storage. There is a need to aggregate a plurality of application programs (APPs) in the server storage system. It is desirable to logically divide resources of the server storage system and execute the plurality of different APPs by using the logically divided different resources so that the performance of any of the APPs does not influence the performance of any of the other APPs. According to PTL 1, the resources of a server and storage system can be logically divided by exclusive allocation of the resources to a plurality of APPs.

### CITATION LIST

### Patent Literature

[PTL 1] Japanese Patent No. 4,227,035

### SUMMARY OF INVENTION

### Technical Problem

The above-mentioned logical division of a portion including a server and a storage can suppress influence of at least one of an adjacent logical partition (LPAR) and virtual machine (VM) (hereinafter collectively referred to as virtual server). However, even in a case where resources equal to or more than allocated resources are required, a resource exclusively allocated to another virtual server cannot be used. Therefore, when the logical division of the portion including a server and a storage is so performed that all virtual servers are involved, the resource use efficiency lowers.

Further, to logically divide the resources in the portion including a server and a storage, a manager needs to configure the resources in each of the server and the storage in such a way that no resource performance competition occurs. It is, however, difficult for a manager who does not have advanced technical knowledge on resource allocation to perform configuration such as that described above.

An object of the present application is therefore to allow a manager to simply perform resource allocation that achieves both improvement in the degree of aggregation of coexisting APPs and prevention of influence on performance.

### Solution to Problem

A server storage system including server systems and storage systems includes a plurality of resources including a plurality of types of resource. The plurality of resources include a plurality of server resources including a plurality of types of server resource provided in the server systems and a plurality of storage resources including a plurality of types of storage resource provided in the storage systems. A management system that manages the server storage system is configured to store allocation control information. The allocation control information is information representing a correspondence among resource types and resource quantities of exclusively allocated server resources and storage resources, resource types and resource quantities of commonly allocated server resources and storage resources, and virtual server load characteristics that are characteristics of a load on a virtual server. The management system is configured to accept a virtual server creation instruction with which one or more types of load characteristic information are associated, the one or more types of load characteristic information being one or more types of information each relating to the virtual server load characteristics and inputted by a manager. The management system is configured to select the exclusively allocated server resources and storage resources based on the allocation control information and the one or more types of load characteristic information. The management system is configured to allocate, when at least one of the server resources and the storage resources is selected, the selected resource to the target virtual server. The allocation control information is changeable information. The “load characteristics of a load on a virtual server” may be load characteristics of a load on a resource (for example, CPU or HBA port, which will be described later) allocated to the virtual server or load characteristics of a load on a resource (for example, VOL, which will be described later) provided to the virtual server. The “load characteristics” may be expected (predicted) load characteristics or actually measured load characteristics. The “resource allocated” to the virtual server is a resource that forms a component of the virtual server as a result of the allocation. On the other hand, the “resource provided” to the virtual server is a resource used by the virtual server (or external apparatus (or computer program) that uses virtual server) (“resource provided” to virtual server is typically not handled as component of virtual server).

### Advantageous Effects of Invention

A manager can simply perform resource allocation that achieves both improvement in the degree of aggregation of APPs and prevention of influence on performance.

### BRIEF DESCRIPTION OF DRAWINGS

FIG. 1 shows an overview of a computer system according to an embodiment.

FIG. 2A shows several examples of resource allocation (logical division) in a server storage system.

FIG. 2B shows a management-side configuration example of the server storage system.

FIG. 3 shows an example of the configuration of an I/O size table.

FIG. 4 shows an example of the configuration of an allocation policy table.

FIG. 5 shows an example of the configuration of an integrated LPAR size template table.

FIG. 6 shows an example of the configuration of a VOL template table.

FIG. 7 shows an example of the configuration of an integrated LPAR table.

FIG. 8 shows an example of the configuration of a server LPAR table.

FIG. 9 shows an example of the configuration of a server LPAR/HBA table.

FIG. 10 shows an example of the configuration of a server HBA table.

FIG. 11 shows an example of the configuration of a storage HBA table.

FIG. 12 shows an example of the configuration of a server/storage coupling table.

FIG. 13 shows an example of the configuration of a storage partition table.

FIG. 14 shows an example of the configuration of a storage partition creation screen.

FIG. 15 shows an example of the configuration of an integrated LPAR creation screen.

FIG. 16 shows an example of the configuration of an integrated LPAR creation overall WF (workflow).

FIG. 17 shows the relationship among components (WF) of an integrated LPAR creation WF in the integrated LPAR creation overall WF.

FIG. 18 shows the procedure of an integrated LPAR creation overall process.

FIG. 19 shows the procedure of an integrated LPAR creation process.

FIG. 20 shows the procedure of a resource selection process.

FIG. 21 shows the procedure of a resource allocation process.

FIG. 22 shows the procedure of a server LPAR creation process.

FIG. 23 shows the procedure of a storage resource allocation process.

FIG. 24 shows the procedure of an allocation control information change process.

FIG. 25 shows an example of the configuration of the server storage system.

FIG. 26 shows an example of the configuration of an integration management server.

FIG. 27 is a diagrammatic view of an overview of an example of providing a WF.

FIG. 28 shows the procedure of a change control process.

FIG. 29 shows an example of error information outputted in a case where the cause of failure is an insufficient server resource.

FIG. 30 shows an example of error information outputted in a case where the cause of the failure is an insufficient storage resource.

### DESCRIPTION OF EMBODIMENTS

An embodiment will be described below. An example of the method for achieving a virtual server is at least one of an LPAR (Logical Partition) and a VM (Virtual Machine), as described above, but in place thereof, for example, a software container may be used. The following description will be made with reference to an LPAR as an example of the virtual server, but another method for achieving a virtual server may, of course, be employed. The “server” of the term “virtual server” is not limited to a server in a client-server model and may be interpreted as a computer in a broad sense.

In the following description, information is described in some cases in the form of an “xxx table,” but information may be expressed in any date structure. That is, to indicate that information is independent of a data structure, the “xxx table” can be called “xxx information.” Further, in the following description, the configuration of each table is presented by way of example; one table may be divided into two or more tables, and the entirety or part of two or more tables may be one table.

In the following description, an ID or a name is used as element identification information. In place of or in addition to an ID or a name, another type of identification information may be used.

In the following description, in a case where elements of the same type are not distinguished from one another in the description, a reference character (or character common to reference characters) is used in some cases, and in a case where elements of the same type are distinguished from one another in the description, element identification information (identification information, such as ID or name assigned to element) (or reference character) is used in some cases.

In the following description, an I/O (Input/Output) request is a write request or a read request and may be called an access request.

In the following description, a “program” is used as the subject to describe a process in some cases. Since a program, when executed by a processor (CPU (Central Processing Unit), for example), carries out a specified process by using a storage section (memory, for example) and/or an interface device (communication port, for example) and other components as appropriate, the subject of the description of the process may instead be the processor. A process described by using a program as the subject in the description of the process may be taken as a process carried out by the processor or an apparatus or a system including the processor. The processor is an example of a control section and may include a hardware circuit that carries out part or the entirety of the process. The program may be installed from a program source onto an apparatus, such as a computer. The program source may, for example, be a storage medium readable by a program delivery server or a computer. In the case where the program source is a program delivery server, the program delivery server may include a processor (CPU, for example) and a storage section, and the storage section may further store a delivery program and a program to be delivered. The processor of the program delivery server may then execute the delivery program to cause the processor of the program delivery server to deliver the program to be delivered to another computer. Further, in the following description, two or more programs may be achieved in the form of one program, and one program may be achieved in the form of two or more programs.

In the following description, a management system may be formed of one or more computers. Specifically, for example, in a case where a management computer displays information (specifically, for example, in a case where the management computer displays information by using a display device of the management computer or a case where the management computer (management server, for example) transmits information to be displayed to a remote computer for display purposes (management client, for example)), the management computer is the management system. Further, for example, in a case where a plurality of computers achieve the identical or similar function of the management computer, the plurality of computers (in the case where the computer for display purposes displays information, the plurality of computers may include the computer for display purposes) are the management system. The management computer (management system, for example) may include the following components: an interface device coupled to an I/O system including a display system; a storage section (memory, for example); and a processor coupled to the interface device and the storage section. The display system may be the display device with which the management computer is provided or the computer for display purposes coupled to the management computer. The I/O system may be an I/O device (keyboard and pointing device, touch panel, for example) with which the management computer is provided or a computer for display purposes or another computer coupled to the management computer. The management computer's action of “displaying information to be displayed” is the management computer's action of causing the display system to display the information to be displayed, which may be the management computer's action of displaying the information to be displayed on the display device with which the management computer is provided or the management computer's action of transmitting the information to be displayed to the computer for display purposes (in the latter case, the computer for display purposes displays the information to be displayed). The management computer's action of inputting/outputting information may be the management computer's action of inputting/outputting information from and to the I/O device with which the management computer is provided or the management computer's action of inputting/outputting information from and to a remote computer (computer for display purposes, for example) coupled to the management computer. Outputting information may be displaying the information.

In the following description, a “server LPAR” is an LPAR that exclusively uses at least one of a plurality of resources of a server. A “storage partition” is an LPAR that exclusively uses at least one of a plurality of resources of a storage.

In the following description, an “integrated LPAR” is a word for convenience representing an LPAR to which resources of a server and resources of a storage are both allocated, and the “integrated LPAR” is an example of an LPAR. That is, an integrated LPAR refers to a unit including logically divided resources of the server and the storage in the system. In the present embodiment, an integrated LPAR typically includes at least part of a server LPAR and at least part of a storage partition. The server resources and the storage resources allocated to an integrated LPAR may each be exclusively allocated resources or commonly allocated resources. Specifically, for example, at least one server resource may be exclusively allocated to an integrated LPAR, and at least one storage resource may be exclusively or commonly allocated to the integrated LPAR. Instead, for example, at least one server resource may be commonly allocated to an integrated LPAR, and at least one storage resource may be exclusively or commonly allocated to the integrated LPAR.

In the following description, a “resource” may be an element provided in each of servers and storages that form a server storage system. The element may be a physical element (for example, a CPU, a memory, an HBA (Host Bus Adapter), a port, a drive (physical storage device)) and may be a logical element (for example, a VOL (logical volume)). Further, any of the following elements present external to the servers and the storages may be handled as an example of the “resource:” for example, a relay device present between any set of the servers and the storages (for example, a switch having routing function or a port extension device having no routing function); a relay device present between any set of the servers; and a relay device present between any set of the storages. Further, an element of such a relay device (for example, a port, a core (a controller)) may also be handled as an example of the “resource.”

In the following description, “X is exclusively allocated to Y1” means that X (a resource, for example) is allocated to Y1 (a first integrated LPAR, for example) but is not allocated to Y2 (a second integrated LPAR, for example), which belongs to an OBJECT of the same type as that of Y1 but is another OBJECT. As a result, X is exclusively used by Y1. Such allocation control may be performed by the management system. For example, after X is exclusively allocated to Y1, the management system performs control in such a way that X is not allocated to any OBJECT other than Y1. On the other hand, “X is commonly allocated to Y1” means that X is allocated to Y1 and can also be allocated to Y2. As a result, X is commonly used by Y1 and Y2. Such allocation control may be performed by the management system. For example, even after X commonly allocated to Y1, the management system performs control in such a way that X may be allocated to any OBJECT other than Y1.

In the following description, an “exclusive resource” is an exclusively allocated resource, and a “common resource” is a commonly allocated resource.

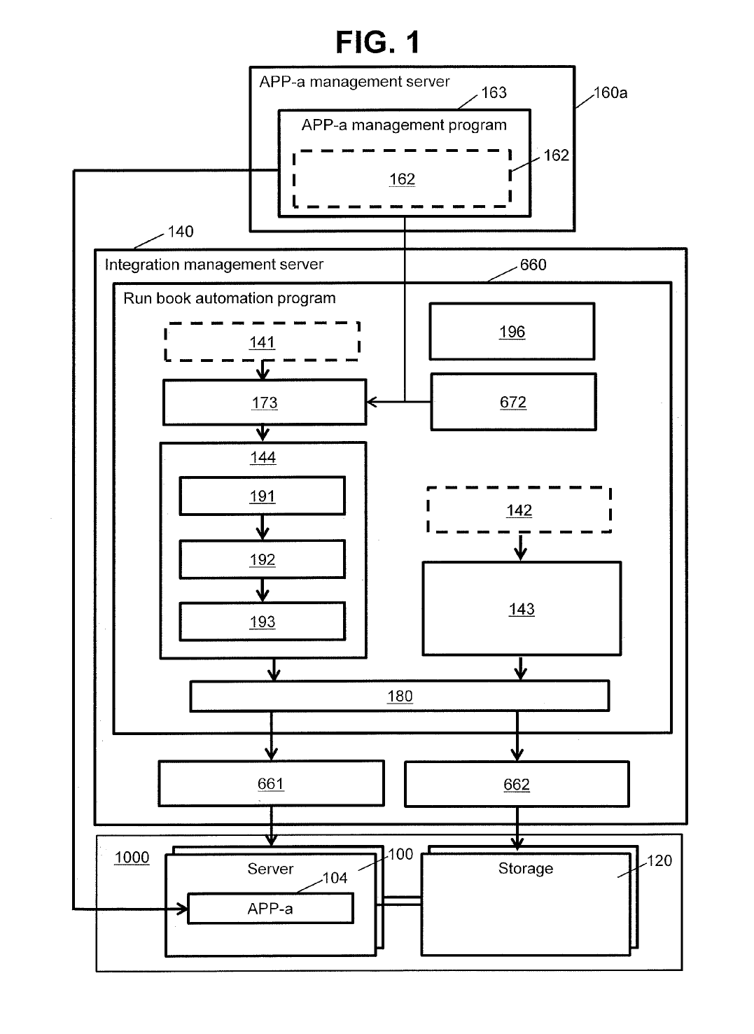

FIG. 1 shows an overview of a computer system according to an embodiment.

An integration management server 140 is an example of a management system that manages a server storage system 1000 including servers 100 and storages 120. The server storage system 1000 includes a plurality of resources including a plurality of types of resource. The plurality of resources include a plurality of server resources including a plurality of types of server resource with which the servers 100 are provided and a plurality of storage resources including a plurality of types of storage resource with which the storages 120 are provided.

The integration management server 140 stores allocation control information 672. The allocation control information 672 is information representing the correspondence among resource types and resource quantities of exclusively allocated server resources and storage resources, resource types and resource quantities of commonly allocated server resources and storage resources, and to LPAR load characteristics, which are the characteristic of a load on an integrated LPAR. The allocation control information 672 is changeable information.

The integration management server 140 displays an integrated LPAR creation screen 141 (or 162). The integrated LPAR creation screen 141 is a GUI (Graphical User Interface) which accepts information on the LPAR load characteristics from a manager (for example, system manager (or tenant manager), which will be described later).

The integration management server 140 accepts an LPAR creation instruction with which one or more types of load characteristic information, which are one or more types of information inputted by the manager to the integrated LPAR creation screen 141, are associated. The integration management server 140 selects an exclusively allocated server resource and storage resource on the basis of the allocation control information 672 and the one or more types of load characteristic information. The integration management server 140, when it has selected at least one of the server resource and the storage resource, allocates the selected resource to a target LPAR. Whenever at least one of the server resource and the storage resource is selected, the resource allocation may be performed, or after both the server resource and the storage resource are selected, the resource allocation may be performed.

Lack of resources that occurs when the resources in the portion including a server and a storage are logically divided, in particular, lack of storage resources in a server storage system 1000 in which the number of storages 120 is fewer than the number of servers 100 can thus be avoided.

The manager does not need to input parameters for the resource allocation described above (parameters necessary for creation of integrated LPAR). The manager only needs to input load characteristic information on the LPAR load characteristics, which are the characteristics of a load on the integrated LPAR, and the integration management server 140 can use the inputted one or more types of load characteristic information to acquire parameters, such as resource types and resource quantities of the exclusively allocated server resource and storage resource, on the basis of the allocation control information 672 and performs the resource allocation described above on the basis of the acquired parameters. Even a manager who does not have advanced technical knowledge on resource allocation can therefore achieve the resource allocation described above.

Further, the allocation control information 672 is changeable information. Therefore, the allocation control information 672 used to create an integrated LPAR in the server storage system 1000 is updated, and the updated allocation control information 672 can be used to change the integrated LPAR or newly create an integrated LPAR. Depending on the environment in which the server storage system 1000 is installed, it may be unnecessary to exclusively allocate as many resources as the resource quantity determined on the basis of initial allocation control information 672 in some cases, or the resource quantity to be exclusively allocated may be more than sufficient or insufficient. In the present embodiment, since the allocation control information 672 is changeable, an integrated LPAR can be created in accordance with differences among environments in which the server storage system 1000 is installed, changes in the environment after the operation starts, and other factors.

An overview of a computer system according to the present embodiment will be described below in detail.

The computer system includes the server storage system 1000, the integration management server 140, which is a management server that manages the server storage system 1000, and one or more APP management servers 160, which manage a plurality of APPs (application programs) 104 aggregated in the server storage system 1000. In the illustrated example, the APPs 104 include an APP-a, and the APP management servers 160 include an APP management server 160a, which manages the APP-a.

The server storage system 1000 includes one or more servers 100 and one or more storages 120. The servers 100 form a server system (one or more server apparatus) having a plurality of resources (plurality of types of resource), such as CPUs and memories. The storages 120 form a storage system (one or more storage apparatus) having a plurality of resources (plurality of types of resource), such as CPUs and memories. The servers 100 and the storages 120 may be accommodated in a single enclosure.

Each of the APP management servers 160 executes an APP management program 163 and is operated, for example, by a tenant manager, which will be described later. The APP management program 163 manages an APP 104 that is a management target and executed by the corresponding server 100. The integration management server 140 causes the APP management server 160 to display an integrated LPAR creation screen 162. The integrated LPAR creation screen 162 is an integrated LPAR creation screen for the APP 104 to be managed by the APP management server 160 and may otherwise be the same as the integrated LPAR creation screen 141. The APP management server 160 transmits an integrated LPAR creation instruction to which parameters (information) inputted by the tenant manager via the integrated LPAR creation screen 162 are associated to the integration management server 140. The APP management servers 160 may be omitted. The integrated LPAR creation instruction may be issued only from the integration management server 140.

The integration management server 140 executes a server management program 661 for managing the servers 100, a storage management program 662 for managing the storages 120, and a run book automation program 660, which is a management program that reduces the manager input burden required for creation of an integrated LPAR.

The server management program 661 functions as a communication interface between the run book automation program 600 and the servers 100. The storage management program 662 functions as a communication interface between the run book automation program 600 and the storages 120.

The run book automation program 660 has, for example, a resource allocation control change function 196, a storage partition creation function 143, an integrated LPAR creation parameter generation function 173, an integrated LPAR creation function 144, and a run book automation engine 180. The integrated LPAR creation function 144 has a resource selection function 191, a resource allocation function 192, and an OS (Operating System) delivery function 193.

The resource allocation control change function 196 is the function of changing the allocation control information 672 in accordance with the manager's operation.

The storage partition creation function 143 and the run book automation engine 180 cooperate with each other to create a storage partition.

Specifically, for example, the storage partition creation function 143 displays a storage partition creation screen (GUI (Graphical User Interface) screen, for example) 142, for example, on a display device of the integration management server 140. The storage partition creation screen 142 is a screen for inputting information (parameters, for example) necessary for creation of a storage partition (FIG. 14). The storage partition creation function 143 inputs the information inputted to the storage partition creation screen 142 to the run book automation engine 180. The run book automation engine 180 creates a configuration based on the inputted information in a storage 120 via the storage management program 662.

As described above, the storage partition creation function 143 and the run book automation engine 180 cooperate with each other to create a storage partition in a storage 120.

The integrated LPAR creation parameter generation function 173, the integrated LPAR creation function 144, and the run book automation engine 180 cooperate with one another to create an integrated LPAR.

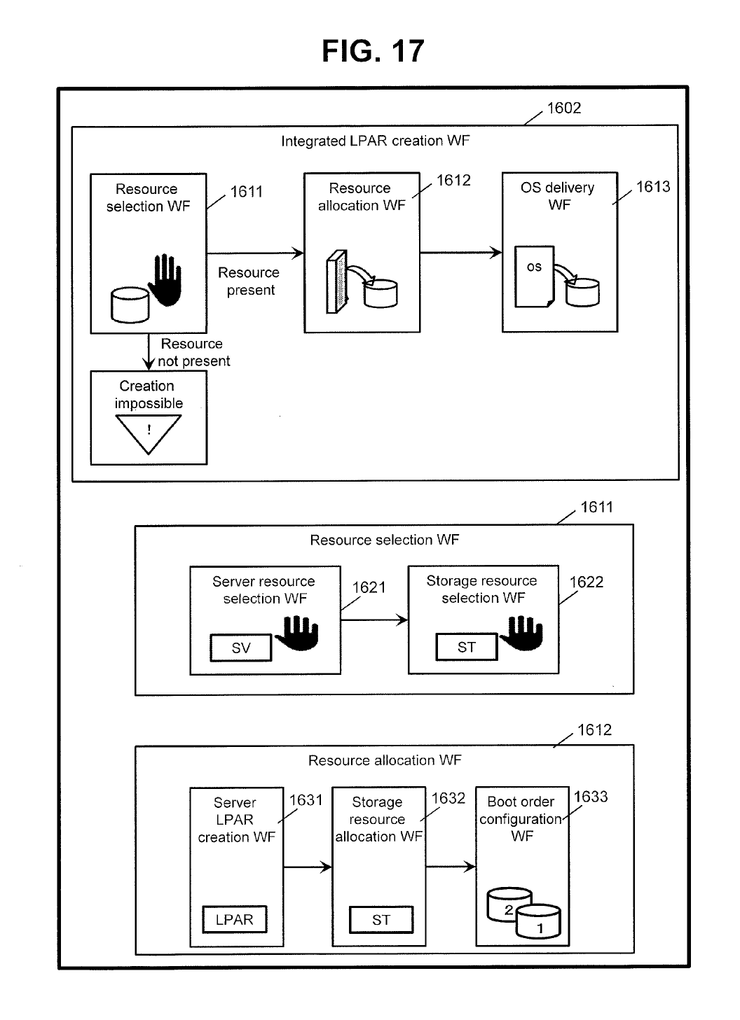

Specifically, for example, the integrated LPAR creation function 144 displays the integrated LPAR creation screen (GUI screen, for example) 141, for example, on the display device of the integration management server 140 and/or displays the integrated LPAR creation screen 162 on the APP management server 160. The integrated LPAR creation screen 162 is a screen as an interface with the tenant manager, and the integrated LPAR creation screen 141 is a screen as an interface with the system manager. The integrated LPAR creation screen 141 (and 162) is a screen for inputting one or more types of load characteristic information (FIG. 17). The integrated LPAR creation parameter generation function 173 uses the one or more types of load characteristic information inputted via the integrated LPAR creation screen 141 (or 162) to acquire parameters necessary for creation of an integrated LPAR (for example, resource type, allocation type (exclusive allocation or common allocation), and resource quantity (number of CPU cores, memory capacity, for example)) from the allocation control information 672. The term “acquisition” used herein may, for example, include “generation” of at least one parameter (at least one of parameters necessary for creation of integrated LPAR) on the basis of at least one of the load characteristic information and information acquired from the allocation control information 672 by use of the load characteristic information.

The resource selection function 191 selects a server resource and a storage resource according to the acquired (generated) parameters. The resource allocation function 192 allocates the selected server resource and storage resource. Specifically, for example, the resource allocation function 192 inputs parameters containing the resource type and the resource quantity of the selected server resource and parameters containing the resource type and the resource quantity of the selected storage resource to the run book automation engine 180. The run book automation engine 180 creates a configuration based on the inputted parameters in the server 100 via the server management program 661 and in the storage 120 via the storage management program 662.

As described above, the integrated LPAR creation parameter generation function 173, the integrated LPAR creation function 144, and the run book automation engine 180 cooperate with one another to create an integrated LPAR in the server storage system 1000.

In the present embodiment, in addition to the creation of an integrated LPAR, a configuration for activation of the created integrated LPAR using an activation image thereof is automatically created for the integrated LPAR.

Specifically, for example, the OS delivery function 193 creates activation data (script file, for example) that is a file that the integrated LPAR refers to when it is activated and configures the created activation data in a memory or any other area of the integrated LPAR. The integrated LPAR can refer to the activation data to acquire the activation image of the integrated LPAR, and the integrated LPAR can be activated by using the activation image.

Instead, for example, the OS delivery function 193 configures the activation image of the integrated LPAR in a data VOL out of one or more of VOLs mounted on the integrated LPAR (VOL the intended use of which is “data” (VOL intended use, which will be described later)) and configures a path used to refer to the activation image at the time of activation in the memory or any other area of the integrated LPAR. The action of configuring the activation image (including OS image) may be an action of causing the OS delivery function 193 to write the activation image in the data VOL or an action of causing the storage 120 to copy the activation image from a copy-source VOL to a copy-destination VOL (data VOL) in response to a copy instruction transmitted from the OS delivery function 193 to the storage 120.

The thus configured OS delivery function 193 eliminates the need for the manager's (tenant manager's or system manager's) configuration for the activation of an integrated LPAR in the integrated LPAR. Typically, a plurality of VOLs are mounted on an integrated LPAR, and a user of the integrated LPAR does not know which of the plurality of VOLs is appropriate for an activation VOL. The OS delivery function 193, however, readily allows configuration of a recommended environment because when an integrated LPAR is created, an activation image of the integrated LPAR is automatically configured in a data VOL.

The present embodiment will be described below in detail.

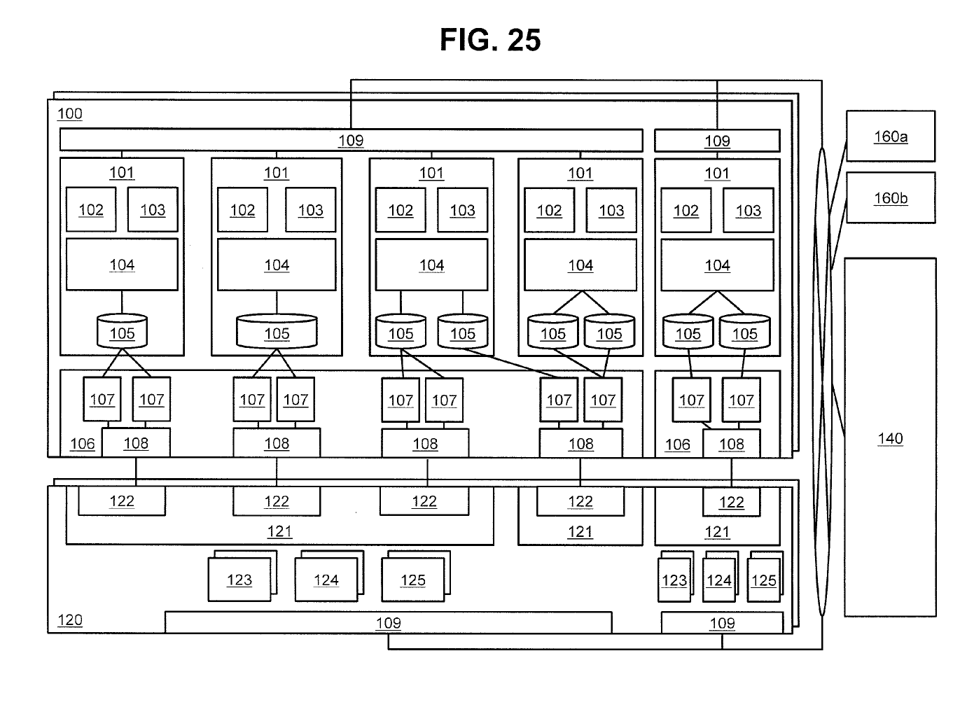

FIG. 25 shows an example of the configuration of the server storage system 1000.

The servers 100, the storages 120, the APP management servers 160, and the integration management server 140 are coupled to a communication network (IP (Internet Protocol) network, for example) 2100. The APP management servers 160 can communicate with the servers 100 in relation to the APPs to be managed and transmit an integrated LPAR creation instruction to the integration management server 140 via the communication network 2100. The integration management server 140 can receive the integrated LPAR creation instruction from any of the APP management servers 160, collect information (configuration of each server 100, configuration of each storage 120, and operation status of each resource, for example) from the server storage system 1000, construct a storage partition, and construct an integrated LPAR. The integration management server 140 may collect metric values of at least part of the plurality of resources via the communication network 2100 and display not only whether the at least part of the resources are exclusively or commonly allocated but also the collected metric values. Examples of the metric values may conceivably include the state, performance value, load value, temperature, quantity in use, and other factors of a resource, and other measurable value of the resource may also be metric values.

The servers 100 each include NICs (Network Interface Cards) 109, CPUs 102, memories 103, and HBAs (Host Bus Adaptors) 106. The servers 100 can communicate with the APP management servers 160 and the integration management server 140 via the NICs 109.

Server LPARs 101 are constructed in each of the servers 100. The server LPARs 101 may each execute a hyper-visor that generates a VM (Virtual Machine) and the generated VM or may be the VM itself. The server LPARs 101 each include one or more CPUs 102 (CPU cores) and one or more memories 103, execute at least one APP 104, and recognize at least one VOL (logical volume) 105. The APPs 104 may each be a database management system or a program, such as a data analysis program. Each of the APPs 104 can issue an I/O request specifying a VOL 105 recognized by the corresponding server LPAR 101 to input and output data from and to the VOL 105. In FIG. 25, the solid lines between the APPs 104 and the VOLs 105 represent the association between the APPs 104 and VOLs 105.

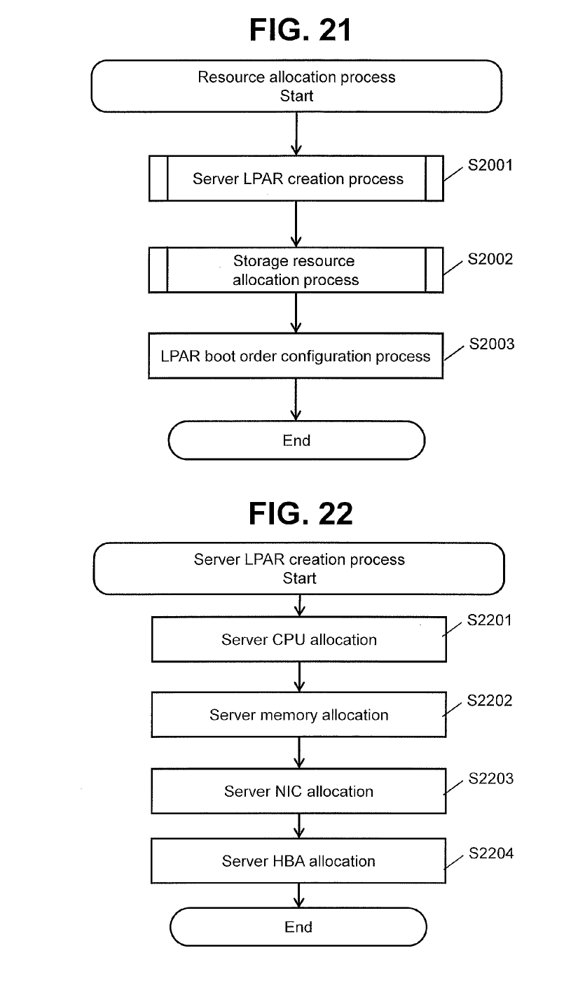

The HBAs 106 are each an interface device for coupling the corresponding server 100 and storage 120 to each other. The HBAs 106 include CTLs (controllers) 107 and ports 108. The CTLs correspond to cores of the HBAs 106 and control transfer of requests and responses via the HBAs 106. In FIG. 21, the solid lines between the VOLs 105, the CTLs 107, and the ports 108 represent the association among the VOLs 105, the CTLs 107, and the ports 108. That is, the VOLs 105 and the ports 108 are associated with the CTLs 107. Each of CTLs 107 can transmit and receive an I/O request and data via the port 108 associated with the CTL 107.

In the present embodiment, the resources of each of the servers 100 are the CPU cores, the memories, the ports of the NICs 109, the HBAs 106, the CTLs 107, and the ports 108.

The storages 120 each include HBAs 121, CPUs 123, memories 124, and drives 125.

The HBAs 121 each have ports 122. In FIG. 25, the solid lines between the ports 122 and 108 represent the association between the ports 122 and 108. Each of the storages 120 communicates with the corresponding server 100 (server LPARs 101) via each of the ports 122 and the port 108 associated with the port 122. For example, in accordance with an I/O request received from a server 100 via any of the ports 122, the corresponding CPU 123 inputs and outputs data from and to the drive 125 identified on the basis of the I/O request. The memories 124 may each have, for example, a program executed by the corresponding CPU 123, a cache area that temporarily stores the inputted and outputted data from and to the corresponding drive 125, and management information for control of the corresponding storage 120. The drives 125 are each a physical storage device, typically, a nonvolatile storage device (auxiliary storage device, for example). The drives 125 may each, for example, be an HDD (Hard Disk Drive) or an SSD (Solid State Drive). A plurality of the drives 125 may form a RAID (Redundant Array of Independent (or Inexpensive) Disks) group. The RAID group stores data in accordance with the RAID level associated with the RAID group. The RAID group may also be called a parity group. The parity group may, for example, be a RAID group that stores parity.

In the present embodiment, the resources of each of the storages 120 are the HBAs 121, the ports 122, the CPUs 123 (or CPU cores), the memories 124, and the drives 125.

The storages 120 each have a first-type resource that processes a request, such as an I/O request, and a second-type resource that is a resource of a type different from the type of the first-type resource. The first-type resource is at least one of a resource relating to a path along which a request is conveyed and a resource relating to processing of the request, and the first-type resource is, for example, the CTLs 107 in each of the HBAs 106 and the CPUs 123 in each of the storages 120. The second-type resource is, for example, the server HBA ports 108 and the storage HBA ports 122.

The relationship between the first-type resource and the second-type resource is, for example, as follows: That is, in a case where the transfer bandwidth of I/O from and to any of the server LPARs 101 does not change but the frequency of I/O, such as IOPS (I/O Per Second), increases, the load on the first-type resource (ratio of first-type resource to maximum load, for example) becomes greater than the load on the second-type resource. Conversely, in a case where the frequency of I/O from and to any of the server LPARs 101 does not change but the I/O transfer bandwidth increases, the load on the second-type resource becomes greater than the load on the first-type resource.

In the present embodiment, in consideration of the above-mentioned relationship between the first-type resource and the second-type resource, the run book automation program 660 causes the types, numbers, and other factors of resources allocated to a plurality of integrated LPARs to differ from one another (in other words, the run book automation program 660 causes the configurations of a plurality of integrated LPARs obtained by logically dividing the server storage system 1000 to differ from one another), as will be described later.

In the present embodiment, the resources of each of the servers 100 are the CPUs 102, the memories 103, the NICs 109, the HBAs 106, the CTLs 107, and the HBA ports 108. As the resources of each of the servers 100, at least one of the resources may be replaced with at least one resource of another type. In the present embodiment, since at least one of the two types of the CPUs 102 and the memories 103 is always exclusively allocated to each of the server LPARs 101 (in other words, the at least one type of resource is a component of each of the server LPARs 101), whether this resource is exclusively or commonly allocated is not selected.

In the present embodiment, the resources of each of the storages 120 are the HBAs 121, the CPUs 123, the memories 124 (for example, cache memories, in particular), and the drives 125 (for example, RAID group, in particular). As the resources of each of the storages 120, at least one of the resources may be replaced with at least one resource of another type. The resource of another type may, for example, be a pool based on the RAID group. A storage area may be allocated from the pool to a virtual VOL in accordance with thin provisioning.

In the present embodiment, the protocol of the communication between the servers 100 and the storages 120 is an FC (Fibre Channel) protocol and may be another protocol (PCI-Express, for example). In a case where another protocol is employed, the HBAs 106 of the servers 100 and the HBAs 121 of the storages 120 may be replaced with interface devices for communication according to the employed protocol. The interface devices each typically have one or more ports. The interface devices may each include a communication controller (control chip, for example) associated with the ports. The communication controller can control transmission and reception of data and requests, as the CTLs 107 can.

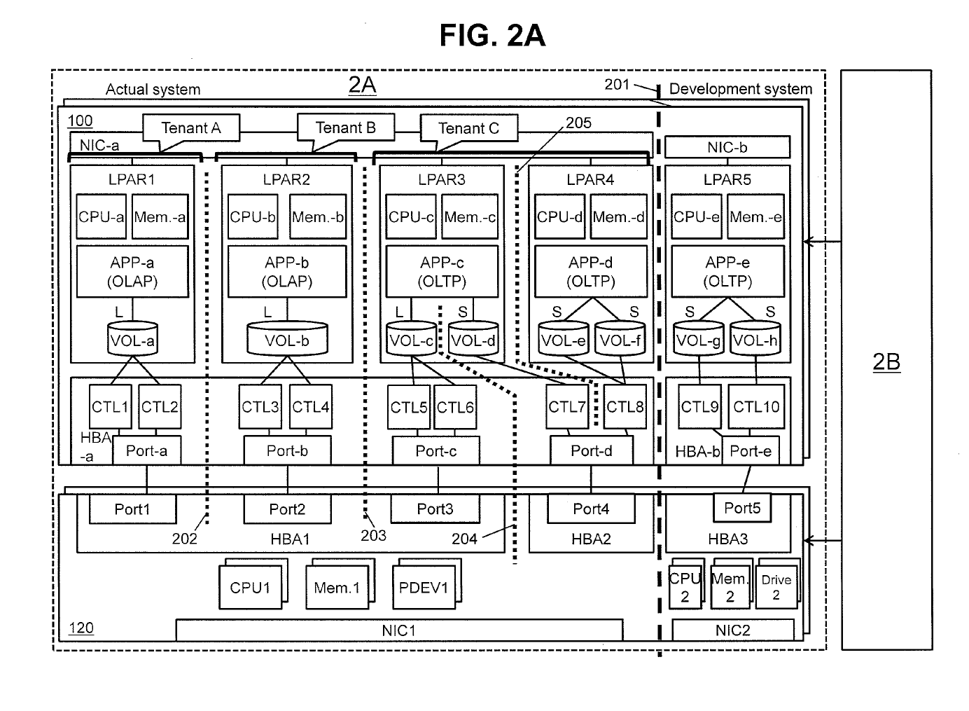

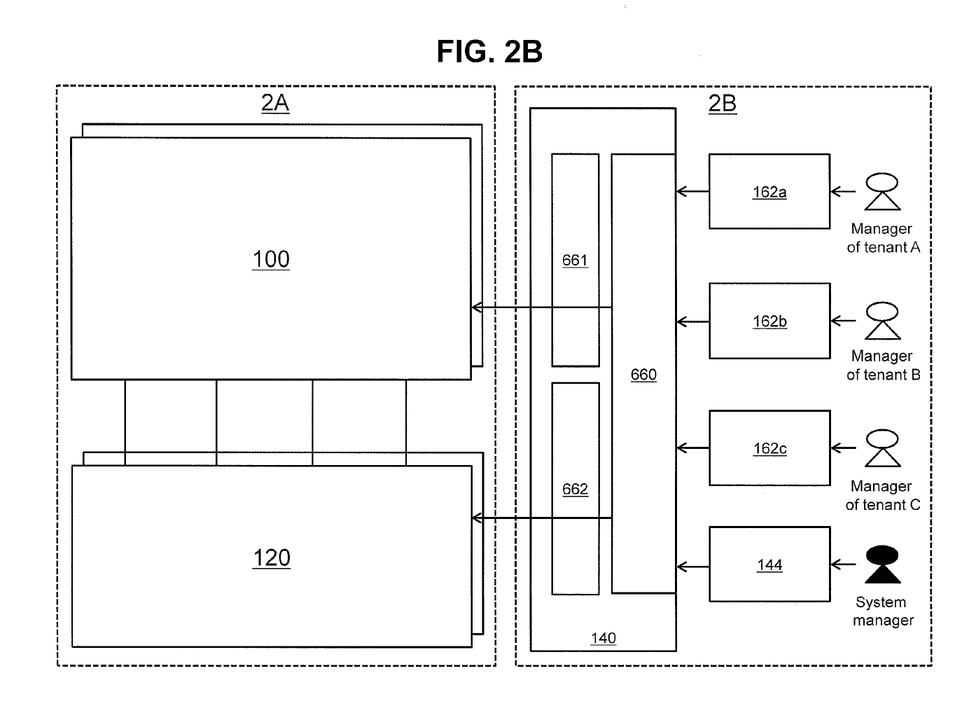

FIG. 2A shows several examples of resource allocation (logical division) in the server storage system 1000. FIG. 2B shows a management-side configuration example of the server storage system 1000. In FIG. 2A, a block representing a resource of the server storage system 1000 is labeled with a name or an ID in place of a reference character. Further, in FIG. 2A, the letter “L” written in the vicinity of a VOL 105 (VOL-a, for example) means a “large” I/O size, and the letter “S” written in the vicinity of a VOL 105 (VOL-d, for example) means a “small” I/O size. Further, in the following description, the “tenant” is a user who uses or manages an integrated LPAR in the server storage system 1000. The “tenant manager” is a manager who manages an integrated LPAR used or managed by the manager's tenant out of one or more tenants, and the “tenant manager” is, for example, the tenant itself or an employee in the tenant. The “system manager” is a manager who manages the entire server storage system 1000 created by integrated LPARs used or managed by the one or more tenants. Reference characters 2A and 2B written in FIG. 2A and reference characters 2A and 2B written in FIG. 2B correspond to each other.

On the basis of the one or more types of load characteristic information inputted by the tenant manager or the system manager and the allocation control information 672, logical division (resource allocation) that will be described below, for example, is performed.

<1. Preventing Actual System and Development System from Influencing Each Other>

One server storage system 1000 can be used both as an actual system or a development system. The actual system is a system in operation, for example, a system that actually provides a customer with a service on a chargeable basis or at no charge. On the other hand, the development system is a system under development, for example, a system in the course of creation of a configuration for providing a service or a system under test to see, for example, whether or not any problem occurs when a service is actually provided.

For example, in general, in the development system, in which tests and other trials are conducted, it is desirable to generate a larger number of server LPARs 101 than in the actual system. On the other hand, in the actual system, it is desirable to achieve both secureness of the performance of the server LPARs 101 and improvement in the degree of aggregation of the APPs 104. Further, in the development system, a large amount of I/O is produced in some cases when a load test and other tests are conducted. It is desirable not to influence the actual system in the course of providing a service even in the case where a large amount of I/O is issued.

Therefore, in the present embodiment, at the boundary between environments in greatly different situations, such as the actual system and the development system, the run book automation program 660 logically divides a portion of the server storage system 1000, the portion including the servers 100 and the storages 120, to prevent the two environments from influencing each other. That is, the server storage system 1000 is broadly divided into a first server storage subsystem used as the actual system and a second server storage subsystem used as the development system. In other words, each of the resources of the server storage system 1000 is exclusively allocated to the actual system or the development system. The configuration described above can prevent the development system from influencing the performance of the actual system.

Further, in the present embodiment, the run book automation program 660 causes a resource allocation (resource division) policy in the actual system to differ from a resource allocation policy in the development system. It is therefore expected to achieve operation suitable for the characteristics of the actual system and the development system. For example, in the actual system, to achieve both secureness of the performance of the server LPARs 101 and improvement in the degree of aggregation of the APPs 104, whether a resource is exclusively allocated or commonly allocated is determined on the basis of at least one of the type of the resource, the intended use of an APP 104 executed in an LPAR to which the resource is allocated (or LPAR associated with the destination to which the resource is allocated), the intended use of a VOL 105 recognized by the server LPAR 101, and the I/O size corresponding to the APP intended use and the VOL intended use. On the other hand, in the development system, to generate a larger number of server LPARs 101 than in the actual system, resources allocated to a server LPAR 101 in the development system (excluding the CPUs 102 and the memories 103, which form the server LPAR 101, and the VOLs 105 recognized by the server LPAR 101) are all common resources. For example, in FIG. 2, only the LPAR 5 out of one or more LPARs is shown in the development system, but CTL 9, CTL 10, Port-e, Port 5, HBA 3, CPU 2, Mem. 2, Drive 2, and other components may be commonly allocated to a plurality of the LPARs. It is noted that also in the development system, whether a resource is exclusively or commonly allocated may be selected.

In the present embodiment, it is assumed that as the logical division of the portion including the servers 100 and the storages 120, at least the server CPU cores, the server memories, the server HBA CTLs, the server HBA ports, the storage HBA ports, the storage HBAs, the storage CPUs, the storage memories, and the storage drives are exclusively allocated to the actual system or the development system. It is, however, noted that depending on the type of a resource, the resource may not be allocated as described above. In this case, part of the resources is commonly used in some cases. Further, the logical division of the portion including the servers 100 and the storages 120 is not necessarily the division into the actual system and the development system, and may instead be division according to another criterion, such as division into the ranges used by a plurality of customers (tenants).

<2. Resource Allocation in Actual System>

The present embodiment is characterized in that whether a resource is exclusively or commonly used is selected by referring to the characteristics of I/O to be processed in each logical division, for example, the data size (I/O size). In general, a “large” I/O size requires a larger processing load per request than a “small” I/O size because the size of I/O-target data is larger in the former than in the latter. There are different load-intensive resource types in accordance with such a difference in characteristics. Therefore, in the present embodiment, a resource type to be exclusively used is determined in consideration of the characteristics of I/O to be processed. On the other hand, a “small” I/O size tends to require a larger processing load per unit time than a “large” I/O size. The reason for this is that a larger number of requests of I/O each having a “small” I/O size can be issued per unit time than the number of requests of I/O each having a “large” I/O size.

Further, the characteristics of a resource vary on a resource basis. For example, in the case where the I/O transfer bandwidth does not change but the I/O frequency increases, the load on the first-type resource becomes larger than the load on the second-type resource. Further, for example, in the case where the frequency of I/O from and to a logical partition does not change but the I/O transfer bandwidth increases, the load on the second-type resource becomes larger than the load on the first-type resource in some cases.

<2-1. Prevention of Influence Between “Large” I/O Sizes>

At least in the actual system out of the actual system and the development system, whether a variety of resources are each exclusively or commonly allocated is selected, as described above. As indicated by reference characters 202 and 203, at least the server HBA ports 108 or the storage HBA ports 122 are not commonly used by a plurality of server LPARs 101 (or APPs 104 or VOLs 105) each associated with a “large” I/O size. In other words, a plurality of different server HBA ports 108 and a plurality of different storage HBA ports 122 are allocated (for example, exclusively allocated) to a plurality of server LPARs 101 (or APPs 104 or VOLs 105) each associated with a “large” I/O size. Specifically, for example, Port-a and Port 1 are allocated to LPAR 1 (or APP-a or VOL-a) associated with a “large” I/O size, and Port-b (server HBA port different from Port-a) and Port 2 (storage HBA port different from Port 1) are allocated to another LPAR, LPAR 2 (or APP-b or VOL-b) associated with a “large” I/O size.

In processing of large-size I/O, in particular, since the performance of a port is lower than the performance of the other resources, the bandwidth per port is likely to be a bottleneck. However, even when a load is excessive as compared with the load acceptable by the bandwidth per server HBA port and the bandwidth per storage HBA port, the configuration described above prevents the excessive load from influencing the other one of the server HBA port and the storage HBA port associated with the “large” and “large” I/O sizes. As a result, an adverse effect between the “large” I/O sizes can be avoided.

A storage HBA 121 may be commonly used by a plurality of VOLs 105 each associated with a “large” I/O size. According to the example shown in FIG. 2, the storage HBA 1 is commonly used by VOL-a, VOL-b, and VOL-c (LPAR 1 to LPAR 3), each associated with a “large” I/O size. Common use of a storage HBA 121 by a plurality of VOLs 105 each associated with a “large” I/O size is defined, for example, in an allocation policy table 146 (see FIG. 4).

Further, the CTLs 107, which are resources having a level higher than the level of the server HBA ports 108, may also be so allocated as not to be commonly used by a plurality of server LPARs 101 (or APPs 104 or VOLs 105) each associated with a “large” I/O size. The resources of the server storage system 1000 have a dependent relationship, for example, a tiered topology configuration (no root may be present). Among resources having levels higher than the level of a target resource, a resource one-level higher than the target resource can be called a “parent resource,” and among resources having levels lower than the level of the target resource, a resource one-level lower than the target resource can be called a “child resource.” The concept of the “higher level/lower level” or the “parent/child” can vary in accordance with a resource to be managed (monitored, for example) but may be defined in accordance with a predetermined criterion. For example, in a case where resources are “coupled” to each other, one of the resources may be a lower-level resource, and the other resource that depends on the one resource (is based on the one resource) may be a higher-level resource. In a case where one resource is “contained” in the other resource, one of the resources may be a lower-level resource, and the other resource that contains the one resource may be a higher-level resource.

<2-2. Prevention of Influence Between “Large” I/O Size and “Small” I/O Size>

As indicated by reference character 204, at least the server HBA CTLs 107 or the storage HBAs 121 are not commonly used by server LPARs 101 (or APPs 104 or VOLs 105) each associated with a “large” I/O size or server LPARs 101 (or APPs 104 or VOLs 105) each associated with a “small” I/O size. In other words, a plurality of different server HBA CTLs 107 and a plurality of different storage HBAs 121 are allocated (for example, exclusively allocated) to server LPARs 101 (or APPs 104 or VOLs 105) each associated with a “large” I/O size and server LPARs 101 (or APPs 104 or VOLs 105) each associated with a “small” I/O size. Specifically, for example, CTLs 5 and 6 and HBA 1 are allocated to VOL-c associated with a “large” I/O size. CTL 7 (server HBA CTL different from CTLs 5 and 6) and HBA 2 (storage HBA different from HBA 1) are allocated to VOL-d associated with a “small” I/O size.

In general, since a “large” I/O size requires a larger processing load on a CTL per request than a “small” I/O size because the size of I/O-target data is larger in the former than in the latter, as described above. Therefore, allocating different server HBA CTLs 107 and different storage HBAs 121 to server LPARs 101 (or APPs 104 and VOLs 105) associated with different I/O sizes can prevent, even when a large load acts on one of the resources associated with a “large” I/O size and a “small” I/O size, particularly, the resource associated with a “large” I/O size, the large load from influencing the server HBA CTL 107 and the different storage HBA 121 associated with the other size.

In a case where a storage HBA has an exclusively allocatable CTL (HBA core), as in the case of a server HBL, allocation to server LPARs 101 (or APPs 104 or VOLs 105) each associated with a “large” I/O size and server LPARs 101 (or APPs 104 or VOLs 105) each associated with a “small” I/O size may be controlled on a storage HBA CTL basis in place of allocation on a storage HBA basis.

<2-3. Prevention of Influence Between “Small” I/O Sizes>

As indicated by reference character 205, at least the server HBA CTLs 107 are not commonly used by a plurality of server LPARs 101 (or APPs 104 or VOLs 105) each associated with a “small” I/O size. In other words, a plurality of different server HBA CTLs 107 are allocated (for example, exclusively allocated) to a plurality of server LPARs 101 (or APPs 104 or VOLs 105) each associated with a “small” I/O size. Specifically, for example, CTL 7 is allocated to LPAR 3 (or APP-c or VOL-d) associated with a “small” I/O size, and CTL 8 (server HBA CTL different from CTL 7) is allocated to another LPAR, LPAR 4 (or APP-d or VOL-e/VOL-f) associated with a “small” I/O size.

In a case where the I/O size is small, the number of I/O actions to be processed per unit time tends to increases, and a load on an HAB CTL therefore increases. Causing the HBA CTLs to be exclusively used by the server LPARs as described above, even if an excessive load acts on one of server HBA CTLs associated with “small” and “small” I/O sizes, prevents the excessive load from influencing the other one of the server HBA CTLs associated with the “small” and “small” I/O sizes. As a result, no adverse effect between the “small” I/O sizes occurs.

A storage HBA 121 and a storage HBA port 122 may be commonly used by a plurality of VOLs 105 each associated with a “small” I/O size. According to the example shown in FIG. 2, the storage HBA 2 and Port 4 are commonly used by VOL-d, the VOL-e, and the VOL-f each associated with a “small” I/O size. Common use of a storage HBA 121 and a storage HBA port 122 by a plurality of VOLs 105 each associated with a “small” I/O size is defined, for example, in the allocation policy table 146 (see FIG. 4).

In other words, between “small” I/O sizes, it is unnecessary to even allocate different server HBA ports and storage HBA ports (it is unnecessary to exclusively allocate the ports, for example). The reason for this is that in the case where the I/O size is small, the CPU 123 of a storage 120 becomes a bottleneck of the I/O performance before the port of the storage 120 becomes the bottleneck.

Several examples of the resource allocation performed from the viewpoint of the I/O size have been described.

The resource allocation may be performed on the basis of, in place of the I/O size, at least one of another type of I/O characteristic, such as the number of I/O actions and variation in the number of I/O actions, the intended use of an APP, and the intended use of a VOL. For example, for an APP with a large number of I/O actions, a drive may be exclusively allocated.

The resource allocation described above is performed by the run book automation program 660 of the integration management server 140 on the basis of management information (allocation control information 672, in particular) stored in the integration management server 140. Specifically, for example, the run book automation program 660 accepts an input of one or more types of load characteristic information (for example, APP ID, APP characteristic, environment (actual or development environment), and integrated LPAR size (S, M, or L), as will be described later) from the manager and can achieve at least one of the following (Example 1) to (Example 8) on the basis of the one or more types of load characteristic information and the allocation control information 672 in the management information. In other words, the allocation control information 672 is information so configured as to be capable of achieving at least one of the following (Example 1) to (Example 8).

### Example 1

In each of two or more LPARs, an APP that issues an I/O request to a VOL provided by a storage 120 is executed. For each of the two or more LPARs, the load characteristic of the LPAR is I/O characteristics that are the characteristics of I/O from/to the VOL with which the LPAR is provided.

### Example 2

In (Example 1), for each of the two or more LPARs, the I/O characteristics of the LPAR include an I/O size that is the size of I/O target data accompanying the I/O request issued in the LPAR.

### Example 3

In (Example 1), for each of the two or more LPARs, the I/O characteristics of the LPAR are characteristics determined on the basis of an input of the intended use of an APP executed in the LPAR and an input of the intended use of a VOL that is the source and the destination of I/O performed by the APP.

### Example 4

In any of (Example 1) to (Example 3), a plurality of server resources include one or more controllers (CTLs) for one or more first interface devices coupled to a storage 120 and one or more first ports of the one or more first interface devices. A plurality of storage resources include one or more second interface devices coupled to a server 100 and one or more second ports of the one or more second interface devices. Whether at least one of the CTLs, the first ports, the second interface devices, and the second ports is exclusively or commonly allocated to each of two or more LPARs depends on the I/O size of a VOL with which the LPAR is provided.

### Example 5

In (Example 4), different CTLs, different first ports, and different second ports are allocated to LPARs provided with two or more VOLs each associated with a large I/O size, and the second interface devices are commonly allocated. The commonly allocated second interface devices are commonly used by LPARs provided with VOLs associated with the same I/O size.

### Example 6

In (Example 4) or (Example 5), different CTLs and different second interface devices are allocated to an LPAR provided with a VOL associated with a large I/O size and an LPAR provided with a VOL associated with a small I/O size.

### Example 7

In (Example 4), different CTLs are allocated to two or more LPARs provided with VOLs each associated with a small I/O size, and the first ports, the second ports, and the second interface devices are commonly allocated. The commonly allocated second interface device and second ports are commonly used by LPARs provided with VOLs each associated with the same I/O size.

### Example 8

The server storage system 1000 includes a plurality of subsystems obtained by logically dividing the portion including the servers 100 and the storages 120. A first subsystem out of the plurality of subsystems is an actual system that is a subsystem that belongs to an actual environment. A second subsystem out of the plurality of subsystems is a development system that is a subsystem that belongs to a development environment. The actual system includes two or more LPARs.

In the execution of the resource allocation described above, the run book automation program 660 causes operation that the run book automation program 660 permits a tenant manager to perform and operation that the run book automation program 660 permits the system manager to perform to differ from each other, as shown in FIG. 2B. According to FIGS. 2A and 2B, the run book automation program 660 provides tenant managers of tenants A to C with integrated LPAR creation screens 162a to 162c, respectively, and provides the system manager with the integrated LPAR creation screen 141. The run book automation program 660 permits the system manager to create integrated LPARs for the tenants A to C, change the configurations of the integrated LPARs, or otherwise process the integrated LPARs. On the other hand, the run book automation program 660 permits each of the tenant managers to create only an integrated LPAR used or managed by the tenant corresponding to the tenant manager, change the configuration of the integrated LPAR, or otherwise process the integrated LPAR but rejects creation of integrated LPARs used or managed by the other tenants, change in the configurations of the integrated LPARs, or other processing thereof.

The integration management server 140 will be described below in detail.

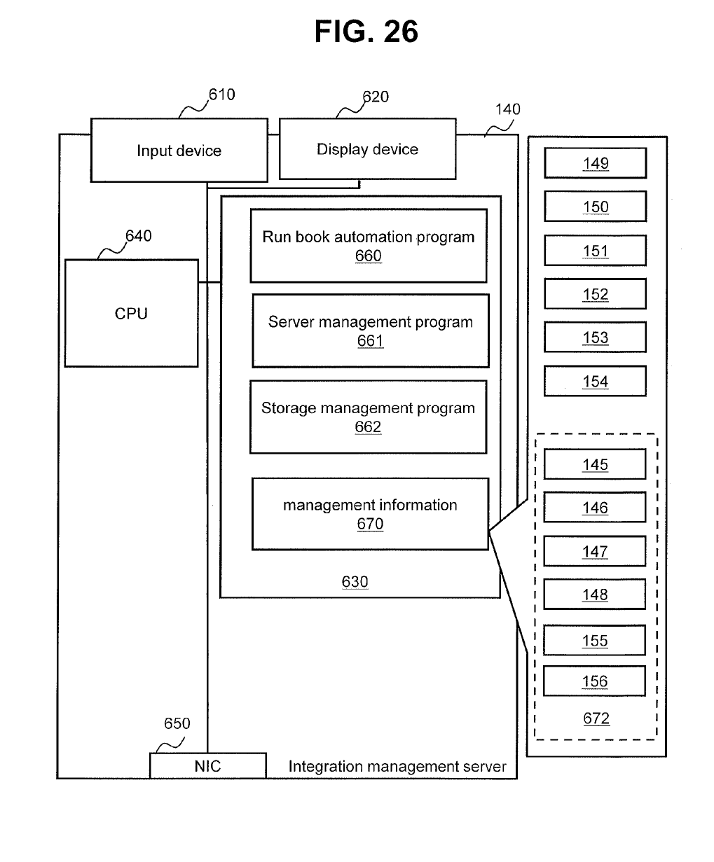

FIG. 26 shows an example of the configuration of the integration management server 140.

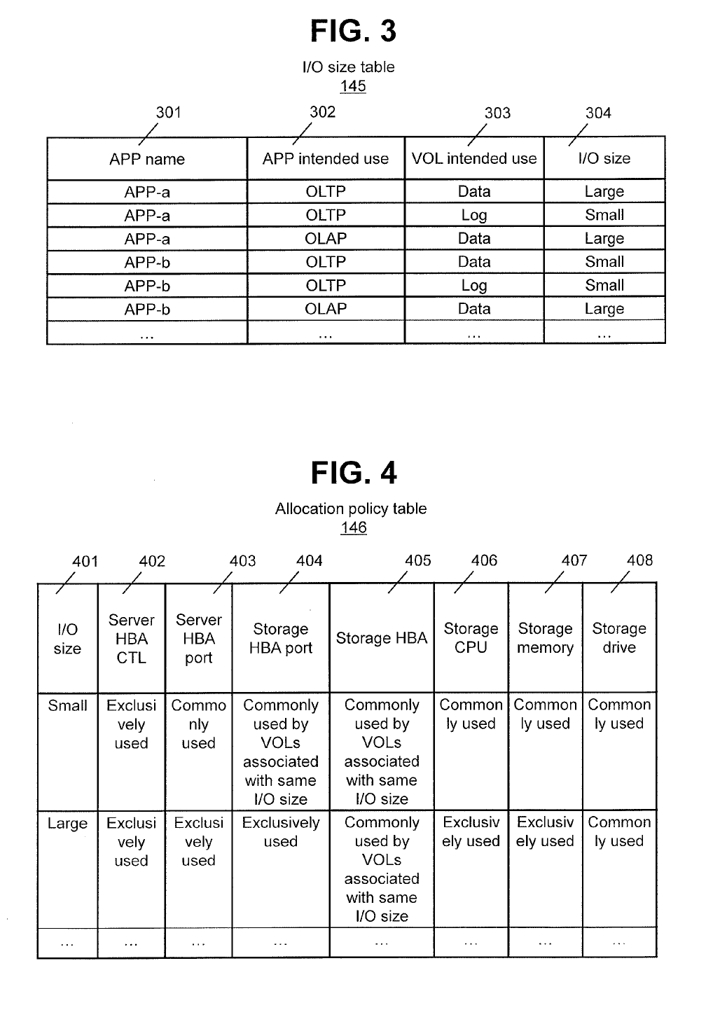

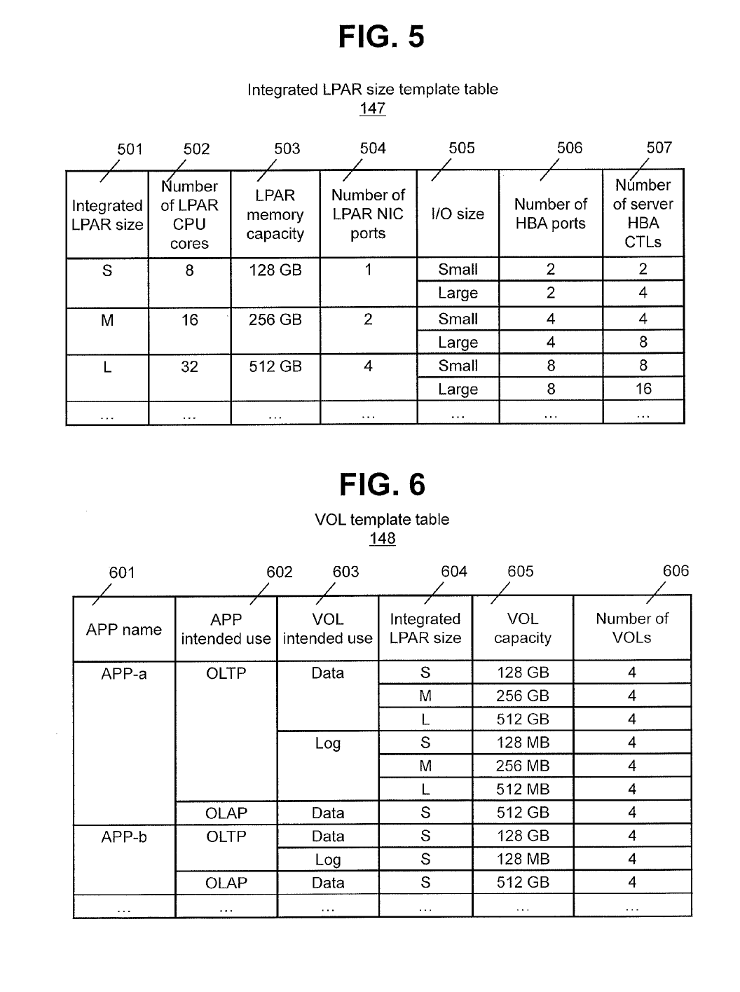

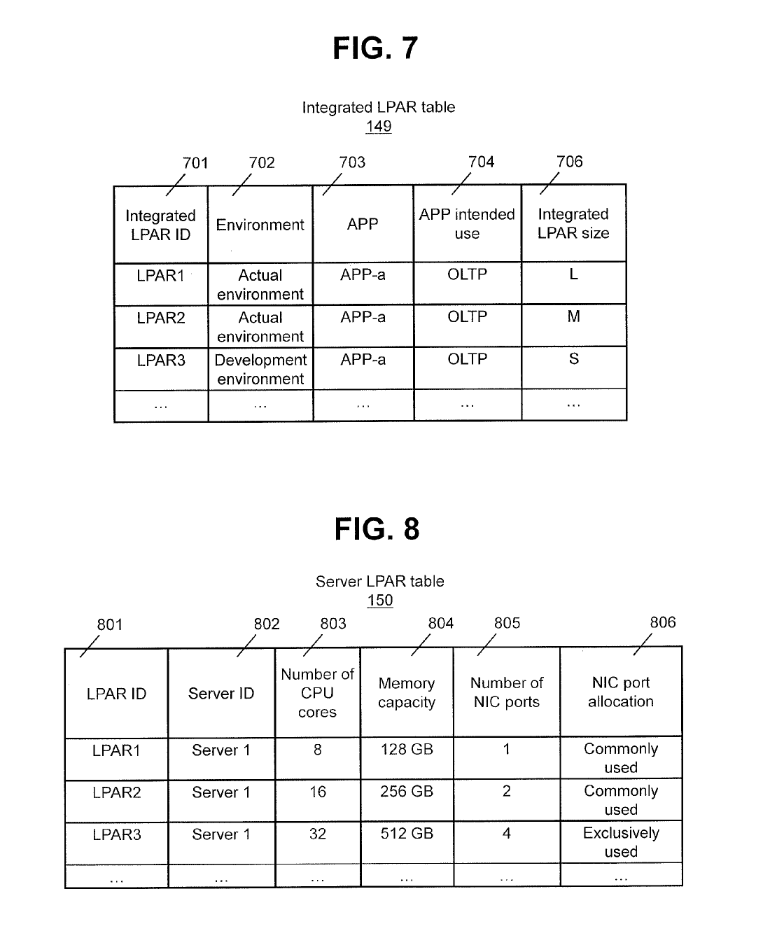

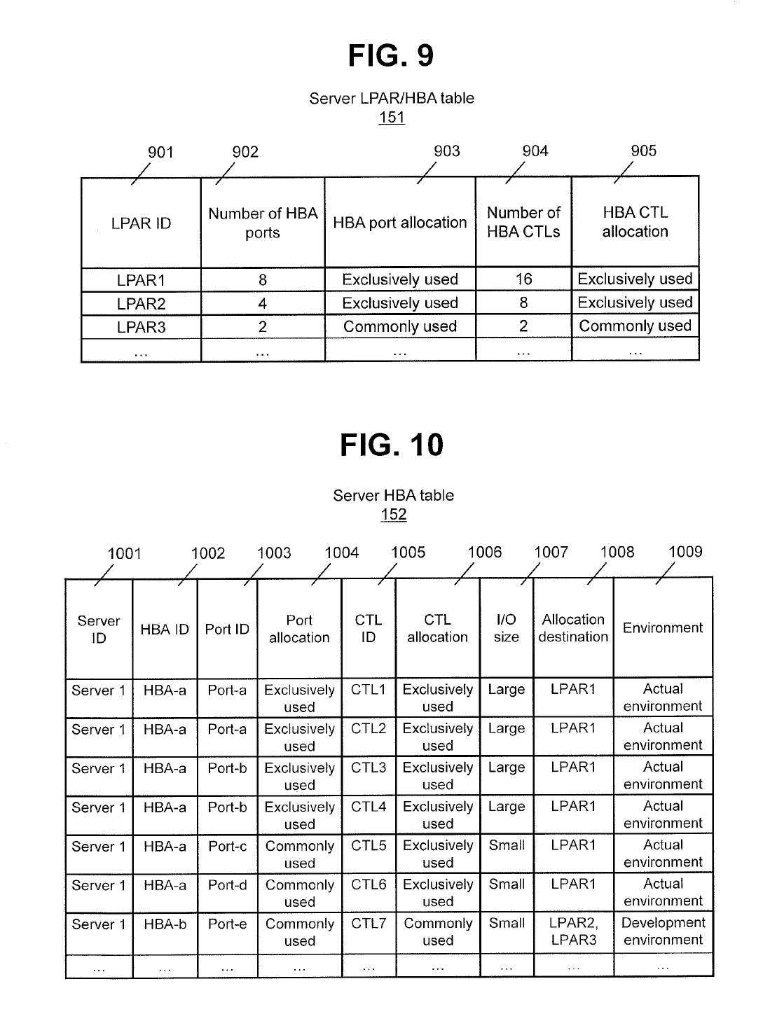

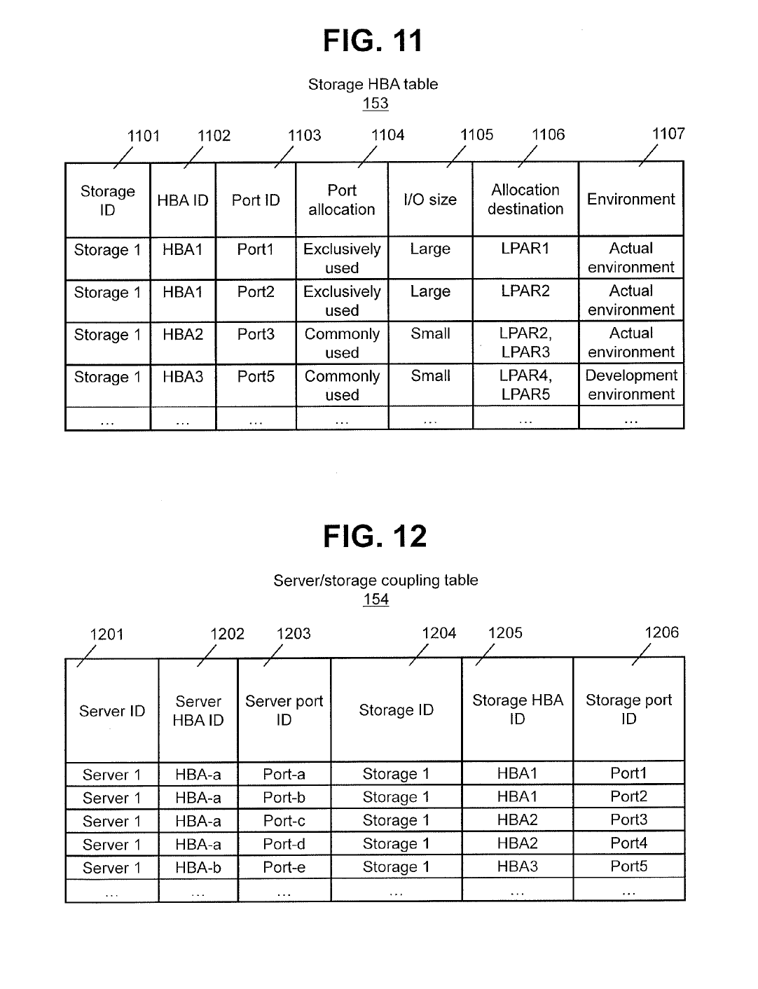

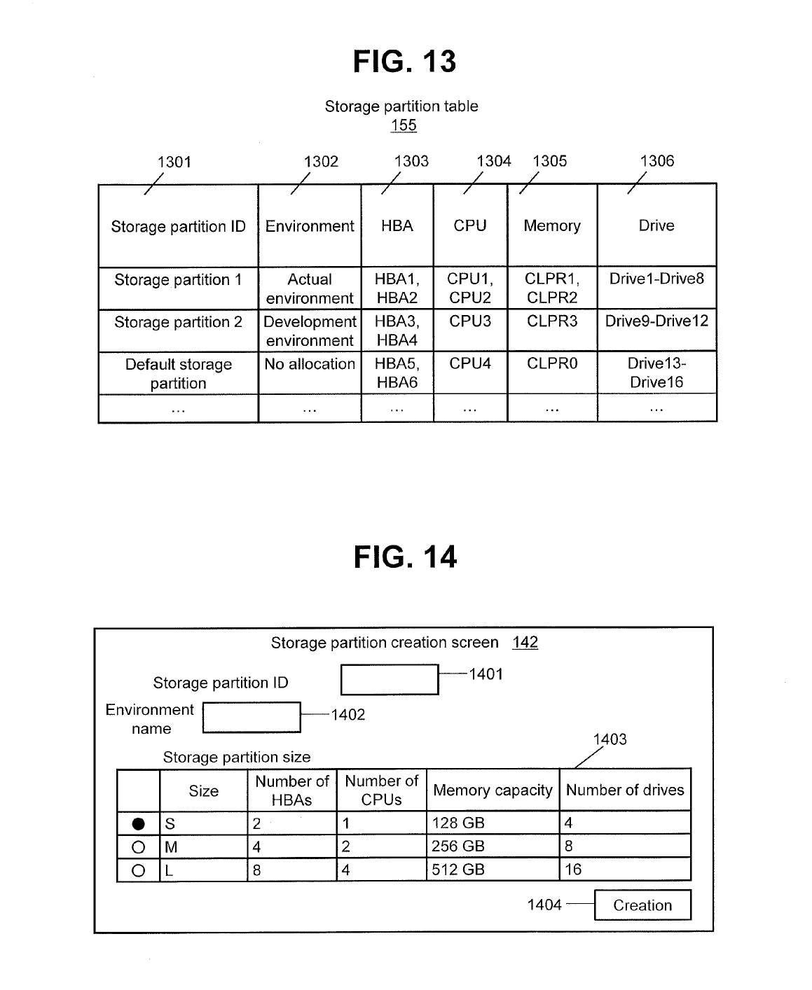

The integration management server 140 includes an input device (keyboard and pointing device, for example) 610, a display device 620, an NIC 650, a storage section (memory, for example) 630, which stores a computer program and information, and a CPU 640, which is coupled to the components described above. The input device 610 and the display device 620 may be integrated with each other as in the case of a touch panel. The integration management server 140 may be coupled to, in place of the input device 610 and the display device 620, a computer for display purposes (personal computer operated by system manager, for example) including an input device and a display device. The computer program stored by the storage section 630 is, for example, the server management program 661, the storage management program 662, and the run book automation program 660, which are executed by the CPU 640. The information stored by the storage section 630 is, for example, management information 670. The management information 670 is information referred to or updated for management of the server storage system 1000 and contains the allocation control information 672 referred to for creation of an integrated LPAR (determination of configuration of integrated LPAR, for example). Specifically, for example, the management information 670 contains an I/O size table 145 (FIG. 3), an allocation policy table 146 (FIG. 4), an integrated LPAR size template table 147 (FIG. 5), a VOL template table 148 (FIG. 6), an integrated LPAR table 149 (FIG. 7), a server LPAR table 150 (FIG. 8), a server LPAR/HBA table 151 (FIG. 9), a server HBA table 152 (FIG. 10), a storage HBA table 153 (FIG. 11), a server/storage coupling table 154 (FIG. 12), a storage partition table 155 (FIG. 13), and a storage partition size template table 156. In the present embodiment, the allocation control information 672 is formed of the tables 145 to 148, 155, and 156, but may not contain part of the tables or may contain at least part of another table.

Each of the tables contained in the management information 670 will be described below.

FIG. 3 shows an example of the configuration of the I/O size table 145.

The I/O size table 145 shows the relationship of the APP name, the APP intended use, and the VOL intended use with the I/O size. The I/O size is an I/O-target data size (average size, for example) that accompanies an I/O request (I/O request specifying VOL 105) from an APP 104. The I/O size is an example of the I/O characteristics of at least one of the APP 104 and the VOL 105. As the I/O characteristics considered for creation of an integrated LPAR, in place of or in addition to the I/O size, at least one of the following parameters can be employed: a read/write ratio (ratio between the number of read requests and the number of write requests); a sequential/random ratio (ratio between the number of sequential I/O actions and the number of random I/O actions); and locality (which is larger, the number of concentrated I/O actions, in which I/O actions are concentrated in a continuous address range, or the number of distributed I/O actions, which are I/O actions in distributed address ranges). In a case where the combination of the I/O size and any of the above-mentioned types of I/O characteristic excluding the I/O size is considered in creation of an integrated LPAR, the run book automation program 660 can place higher priority on the I/O size than the other types of I/O characteristic.

The I/O size table 145 has entries for each APP 104. Information stored in each of the entries includes an APP name (or another type of APP identification information for identifying APP) 301, an APP intended use 302, a VOL intended use 303, and an I/O size 304. The APP name 301 represents the name of an APP 104. The APP intended use 302 represents the intended use of the APP 104. The VOL intended use 303 represents the intended use of the VOL 105 associated with the APP 104. The I/O size 304 represents an I/O size that is the size of I/O-target data from the APP 104 to the VOL 105.

In the present embodiment, as the APP intended use, OLTP (Online Transaction Processing) or OLAP (Online Analytical Processing) is employed. As the APP intended use, another type of intended use may be employed.

Further, in the present embodiment, as the VOL intended use, data storage or log storage is employed. As the VOL intended use, another type of intended use may be employed.

Further, in the present embodiment, as the value of the I/O size 304, “large” that means the I/O size is relatively large (equal to or larger than a predetermined threshold, for example) or “small” that means the I/O size is relatively small (smaller than the predetermined threshold, for example) is employed. The value of the I/O size 304 may be classified into more levels than the two levels, large and small, (three levels, large, middle, and small, for example, may instead be employed). According to the I/O size table 145, the value of the I/O size 304 is determined by the combination of the APP name 301, the APP intended use 302, and the VOL intended use 303.

FIG. 4 shows an example of the configuration of the allocation policy table 146.

The allocation policy table 146 shows policies of the resource allocation according to the I/O size. The allocation policy table 146 has entries for each allocation policy. Information stored in each of the entries includes an I/O size 401, a server HBA CTL 402, a server HBA port 403, a storage HBA port 404, a storage HBA 405, a storage CPU 406, a storage memory 407, and a storage drive 408.

The I/O size 401 represents the I/O size. The server HBA CTL 402 represents a method for allocating a CTL 107. The server HBA port 403 represents a method for allocating a port 108. The storage HBA port 404 represents a method for allocating a port 122. The storage HBA 405 represents a method for allocating an HBA 121. The storage CPU 406 represents a method for allocating a CPU 123. The storage memory 407 represents a method for allocating a memory 124. The storage drive 408 represents a method for allocating a drive 125.

In the allocation policy table 146, the term “Exclusive” means that a resource is exclusively allocated. The term “Common” means that a resource is commonly allocated. The phrase “Commonly used by VOLs associated with the same I/O size” means that a resource is commonly allocated to a plurality of VOLs associated with the same I/O size (in other words, a resource is so allocated as not to be commonly used by a plurality of VOLs associated with different I/O sizes).

In the case where the I/O size is “large,” the ports 108 of a server HBA 106 and the ports 122 of a storage HBA 121 are each likely to be a bottleneck. According to the allocation policy table 146, the CTLs 107 of a server HBA 106, the ports 108 of the server HBA 106, and the ports 122 of a storage HBA 121 are exclusively allocated to a VOL associated with a “large” I/O size.

On the other hand, in the case where the I/O size is “small,” the ports 108 of a server HBA 106 and the ports 122 of a storage HBA 121 are each unlikely to be a bottleneck. When the CTLs 107 of a server HBA 106 are commonly used resources, however, the CTLs 107 are influenced by another load that commonly uses the ports 108 of the server HBA 106. According to the allocation policy table 146, the ports 108 of a server HBA 106 and the ports 122 of a storage HBA 121 are commonly allocated to VOLs each associated with a “small” I/O size, and the CTLs 107 of the server HBA 106 are exclusively allocated.

In the present embodiment, the CTLs (not shown) of a storage HBA 121 cannot be controlled. The CTLs of a storage HBA 121 are therefore commonly used. In the case where the CTLs of a storage HBA 121 is commonly used, a load having a “small” I/O size can be greatly influenced by a load having a “large” I/O size. It is therefore desirable to logically divide a storage HBA 121. Therefore, according to the allocation policy table 146, a storage HBA 121 is commonly allocated to a plurality of VOLs associated with the same I/O size.

In a case where the CTLs of a storage HBA 121 can be exclusively allocated, the allocation policy table 146 may not be so configured that the storage HBA 121 is logically divided. Further, in a case where the CTLs 107 of a server HBA 106 cannot be exclusively allocated, the allocation policy table 146 may be so configured that the server HBA 106 is logically divided.

FIG. 5 shows an example of the configuration of the integrated LPAR size template table 147.

The integrated LPAR size template table 147 shows the quantity of server resource allocated to an integrated LPAR. The integrated LPAR size template table 147 has entries for each integrated LPAR size template. Information stored in each of the entries includes an integrated LPAR size 501, the number of LPAR CPU cores 502, LPAR memory capacity 503, the number of LPAR NIC ports 504, an I/O size 505, the number of HBA ports 506, and the number of server HBA CTLs 507.

The integrated LPAR size 501 represents the size of an integrated LPAR. The value of the integrated LPAR size 501 is classified into three types, large, medium, and small (L/M/S), but the value may instead be classified into two or four or more types. The number of LPAR CPU cores 502 represents the number of CPU cores (the number of cores of CPU 102) allocated to a server LPAR 101. The LPAR memory capacity 503 represents the capacity of the memory 103 allocated to the server LPAR 101. The number of LPAR NIC ports 504 represents the number of NIC ports (ports of NIC 109) allocated to the server LPAR 101. The I/O size 505 represents the I/O size corresponding to the APP 104 and the VOL 105 in the server LPAR 101. The number of HBA ports 506 represents the number of HBA ports 108 associated with the server LPAR 101. The number of server HBA CTLs 507 represents the number of CTLs 107 related to the server LPAR 101.

FIG. 6 shows an example of the configuration of the VOL template table 148.

The VOL template table 148 shows the relationship of the APP name, the APP intended use, the VOL intended use, and the integrated LPAR size with the VOL capacity and the number of VOLs. The VOL template table 148 has entries for each VOL template. Information stored in each of the entries includes an APP name 601, an APP intended use 602, a VOL intended use 603, an integrated LPAR size 604, a VOL capacity 605, and the number of VOLs 606. The APP name 601, the APP intended use 602, the VOL intended use 603, and the integrated LPAR size 604 are the same as those described above. The VOL capacity 605 represents the capacity of a VOL 105. The number of VOLs 606 represents the number of VOLs 105.

FIG. 7 shows an example of the configuration of the integrated LPAR table 149.

The integrated LPAR table 149 shows information on an integrated LPAR. The integrated LPAR table 149 has entries for each integrated LPAR. Information stored in each of the entries includes an integrated LPAR ID 701, an environment 702, an APP name 703, an APP intended use 704, and an integrated LPAR size 706.

The integrated LPAR ID 701 represents the ID of an integrated LPAR. The value of the ID of an integrated LPAR may be equal to the value of the ID of the server LPAR contained in the integrated LPAR. The environment 702 represents an LPAR environment (actual environment or development environment) that is the environment in which the integrated LPAR is relocated. The APP name 703 represents the name of an APP executed in the integrated LPAR. The APP intended use 704 represents the intended use of the executed APP. The integrated LPAR size 706 represents the size of the integrated LPAR.

FIG. 8 shows an example of the configuration of the server LPAR table 150.

The server LPAR table 150 represents the configuration of a server LPAR 101. The server LPAR table 150 has entries for each server LPAR 101. Information stored in each of the entries includes an LPAR ID 801, a server ID 802, the number of CPU cores 803, memory capacity 804, the number of NIC ports 805, and NIC port allocation 806.

The LPAR ID 801 represents the ID of a server LPAR 101. The server ID 802 represents the ID of the server 100 in which the server LPAR 101 operates. The number of CPU cores 803 represents the number of cores of the CPUs 102 allocated to the server LPAR 101. The memory capacity 804 represents the capacity of the memory 103 allocated to the server LPAR 101. The number of NIC ports 805 represents the number of ports of the NIC 109 allocated to the server LPAR 101. The NIC port allocation 806 represents whether the ports of the NIC 109 is exclusively or commonly allocated to the server LPAR 101.

FIG. 9 shows an example of the configuration of the server LPAR/HBA table 151.

The server LPAR/HBA table 151 shows the relationship between a server LPAR 101 and a server HBA 106. The server LPAR/HBA table 151 has entries for each server LPAR 101. Information stored in each of the entries includes an LPAR ID 901, the number of HBA ports 902, HBA port allocation 903, the number of HBA CTLs 904, and HBA CTL allocation 905.

The LPAR ID 901 represents the ID of a server LPAR 101 in a server 100. The number of HBA ports 902 represents the number of server HBA ports 108 allocated to the server LPAR 101. The HBA port allocation 903 represents the state of allocation of the ports 108 (exclusive allocation or common allocation). The number of HBA CTLs 904 represents the number of CTLs 107 allocated to the server LPAR 101. The HBA CTL allocation 905 represents the state of allocation of the CTLs 107 (exclusive allocation or common allocation).

FIG. 10 shows an example of the configuration of the server HBA table 152.

The server HBA table 152 is information on a server HBA 106. The server HBA table 152 has entries for each server HBA CTL 107. Information stored in each of the entries includes a server ID 1001, an HBA ID 1002, a port ID 1003, port allocation 1004, a CTL ID 1005, CTL allocation 1006, an I/O size 1007, an allocation destination 1008, and an environment 1009.

The server ID 1001 represents the ID of a server 100. The HBA ID 1002 represents the ID of an HBA 106. The port ID 1003 represents the ID of a port 108. The port allocation 1004 represents the state of allocation of the port 108 (exclusive allocation, common allocation, or no allocation). The CTL ID 1005 represents the ID of a CTL 107. The CTL allocation 1006 represents the state of allocation of the CTL 107 (exclusive allocation, common allocation, or no allocation). The I/O size 1007 represents the I/O size of a VOL 105 associated with the CTL 107. The allocation destination 1008 represents the ID of a server LPAR 101 to which the CTL 107 is allocated (when no allocation destination is present, “no allocation” may be configured). The environment 1009 represents the environment (actual or development environment) to which the HBA 106 belongs.

FIG. 11 shows an example of the configuration of the storage HBA table 153.

The storage HBA table 153 is information on a storage HBA 121. The storage HBA table 153 has entries for each storage HBA port 122. Information stored in each of the entries includes a storage ID 1101, an HBA ID 1102, a port ID 1103, port allocation 1104, an I/O size 1105, an allocation destination 1106, and an environment 1107.

The storage ID 1101 represents the ID of a storage 120. The HBA ID 1102 represents the ID of an HBA 121. The port ID 1103 represents the ID of a port 122. The port allocation 1104 represents the state of allocation of the port 122 (exclusive allocation, common allocation, or no allocation). The I/O size 1105 represents the I/O size of a VOL 105 associated with the HBA 121. The allocation destination 1106 represents the ID of a server LPAR 101 to which the port 122 is allocated (when no allocation destination is present, “no allocation” may be configured). The environment 1107 represents the environment (actual or development environment) to which the HBA 121 belongs.

Control is so performed that different I/O sizes are not associated with one storage HBA 121. For example, in a case where any one of the ports 122 (first port 122) of an HBA 121 is allocated to a server LPAR 101 (or APP 104 or VOL 105), the I/O size (“large” or “small”) corresponding to the server LPAR 101 (or APP 104 or VOL 105) to which the first port 122 is allocated may be configured as the I/O size 1105 for each of the first port 122 and all the other ports 122 of the HBA 121 having the first port 122. Instead, for example, in the case where the first port 122 of the HBA 121 is allocated to a server LPAR 101 (or APP 104 or VOL 105), a situation in which the I/O size (“large” or “small”) corresponding to the server LPAR 101 (or APP 104 or VOL 105) to which the first port 122 is allocated is configured as the I/O size 1105 for the first port 122 and the run book automation program 660 then associates the server LPARs 101 (or APPs 104 or VOLs 105) associated with the other I/O size with all the other ports 122 of the HBA 121 having the first port 122 may be avoided. In a case where all the ports 122 of the same HBA 121 are “not allocated,” either of the I/O sizes can be associated with the HBA 121.

FIG. 12 shows an example of the configuration of the server/storage coupling table 154.

The server/storage coupling table 154 shows the coupling relationship between a server HBA port 108 and a storage HBA port 122. The server/storage coupling table 154 has entries for each combination of a server HBA port 108 and a storage HBA port 122. Information stored in each of the entries includes a server ID 1201, a server HBA ID 1202, a server port ID 1203, a storage ID 1204, a storage HBA ID 1205, and a storage port ID 1206.

The server ID 1201 represents the ID of a server 100. The server HBA ID 1202 represents the ID of a server HBA 106. The server port ID 1203 represents the ID of a server HBA port 108. The storage ID 1204 represents the ID of a storage 120. The storage HBA ID 1205 represents the ID of a storage HBA 121. The storage port ID 1206 represents the ID of a storage HBA port 122. The server/storage coupling table 154 may be constructed by collection of coupling information from the server 100 and the storage 120.

FIG. 13 shows an example of the configuration of the storage partition table 155.

The storage partition table 155 is information on the configuration of a storage partition. The storage partition table 155 has entries for each storage partition. Information stored in each of the entries includes a storage partition ID 1301, an environment 1302, an HBA 1303, a CPU 1304, a memory 1305, and a drive 1306.

The storage partition ID 1301 represents the ID of a storage partition. The environment 1302 represents the environment (actual or development environment) to which the storage partition belongs. The HBA 1303 represents the ID of an HBA 121 that belongs to the storage partition. The CPU 1304 represents the ID of the CPU 123 that belongs to the storage partition. The memory 1305 represents the ID of a CLPR (Cache Logical Partition) that belongs to the storage partition. The CLPR is a cache memory LPAR obtained by logical division of a memory 124 (cache memory). The drive 1306 represents the ID of the drive 125 that belongs to the storage partition.

The tables contained in the management information 670 have been described above.

The storage partition creation screen 142 and the integrated LPAR creation screen 141 will next be described.

FIG. 14 shows an example of the configuration of the storage partition creation screen 142.

The storage partition creation screen 142 is a screen (GUI, for example) that accepts an input of information for creating a storage partition and an instruction of creation of the storage partition. For example, on the storage partition creation screen 142, a storage partition ID input UI (user interface) 1401, an environment name input UI 1402, a storage partition size selection UI 1403, and a creation instruction UI 1404 are displayed.

The UI 1401 is a UI to which the ID of a storage partition to be created is inputted, and the UI 1401 is, for example, a text input field. The UI 1402 is a UI to which the name of the environment (actual or development environment) to which the storage partition to be created belongs is inputted and, the UI 1402 is, for example, a text input field.

The UI 1403 is a UI that accepts selection of the storage partition size and is formed, for example, of a plurality of radio buttons corresponding to a plurality of storage partition sizes. Specifically, for example, the UI 1403 includes a table showing the relationship of the storage partition size with the number of storage HBAs 121, the number of CPUs 123, the capacity of the memory 124, and the number of drives 125. The table may be the storage partition size template table 156 itself, the information itself contained in the management information 670, or information determined by the run book automation program 660 on the basis of the information and policies contained in the management information 670. A radio button for each storage partition size is displayed in the table provided in the UI 1403.

Information is inputted to the UIs 1401 and 1402, a storage partition desired by the system manager is selected via the UI 1403, and the creation instruction UI 1404 is operated (“creation” button is pressed, for example). A storage partition is thus created.

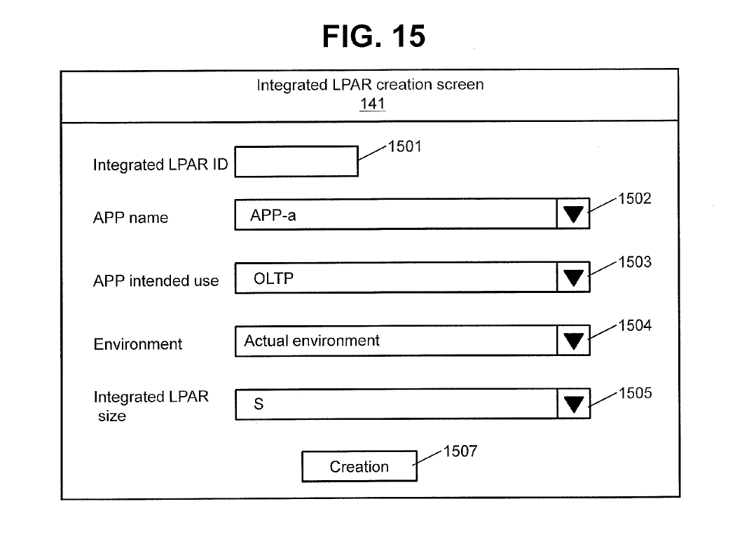

FIG. 15 shows an example of the configuration of the integrated LPAR creation screen 141.

The integrated LPAR creation screen 141 is a screen (GUI, for example) that accepts an input of information for creating an integrated LPAR and an instruction of creation of the integrated LPAR. The information for creating an integrated LPAR contains the integrated LPAR ID allocated to the integrated LPAR to be created and one or more types of load characteristic information, each of which is information on the LPAR load characteristics. In the present embodiment, the one or more types of load characteristic information contain the APP name and the APP intended use of an APP activated in the integrated LAPR to be created. The one or more types of load characteristic information further contain the size of the integrated LPAR to be created and the type of the environment to which the integrated LPAR belongs (actual or development environment). The one or more types of I/O load characteristic information may contain, for example, the I/O characteristics themselves (I/O size, for example) of the APP executed in the integrated LPAR in place of at least part of the information shown in FIG. 15.

The integrated LPAR creation screen 141 includes, for example, an integrated LPAR ID input UI 1501, an APP selection UI 1502, an APP intended use selection UI 1503, an environment selection UI 1504, an integrated LPAR size selection UI 1505, and a creation instruction UI 1507.

The UI 1501 is a UI to which the ID of an integrated LPAR to be created is inputted and, the UI 1501 is, for example, a text input field. The UI 1502 is a UI that accepts selection of the APP name. The UI 1503 is a UI that accepts selection of the APP intended use. The UI 1504 is a UI that accepts selection of the environment. The UI 1505 is a UI that accepts selection of the integrated LPAR size. UIs 1502 to 1505 are each, for example, a pulldown menu.

An integrated LPAR ID is inputted to the UI 1501, an APP name, an APP intended use, an environment, and an integrated LPAR size are selected via the UIs 1502 to 1505, and the creation instruction UI 1507 is operated (“creation” button is pressed, for example). An integrated LPAR is thus created.

The storage partition creation screen 142 and the integrated LPAR creation screen 141 have been described above. Other choice of options may be added as appropriate to the choice of options displayed on the screen 142 and the choice of options displayed in the pulldown menus of the screen 141 (for example, storage partition size, APP name, environment name, APP intended use, and integrated LPAR size) (including changing or deleting the existing choice of options). Further, as for the integrated LPAR creation screen 162 displayed on each of the APP management servers 160, the APPs displayed in the APP selection UI may be limited to APPs to be managed by the APP management server 160.

The procedure of a storage partition creation process carried out in response to the storage partition creation instruction accepted by the run book automation program 660 via the storage partition creation screen 142 is, for example, as follows:

(1400-1) The run book automation program 660 transmits a RAID group creation instruction to the corresponding storage 120. The RAID group creation instruction contains information inputted via the screen 142 (for example, the number of drives corresponding to the selected storage partition size). As a result, the storage 120 creates, in response to the creation instruction, a RAID group formed of drives the number of which is associated with the creation instruction. The RAID level of the RAID group may be a pre-specified RAID level. In a case where different types of drive 125 are present (in a case where HDDs and SSDs are both present, for example), a RAID group formed of drives of the same type (RAID group formed of HDDs or RAID group formed of SSDs, for example) may be created. Further, a pool based on the created RAID group may also be created.

(1400-2) The run book automation program 660 transmits a CLPR creation instruction to the storage 120. The CLPR creation instruction contains information inputted via the screen 142 (for example, memory capacity corresponding to selected storage partition size). The storage 120 creates, in response to the creation instruction, CLPR having the memory capacity associated with the creation instruction. In the case where different types of drive 125 are present (in the case where HDDs and SSDs are both present, for example), the CLPR may be created on a drive type basis.

(1400-3) The run book automation program 660 updates the storage partition table 155 on the basis of the information inputted via the screen 142 and the information on the created RAID group and CLPR. For example, the IDs of the storage HBA 121, the CPU 123, the CLPR, and the drive 125 determined by the storage 120 in accordance with the number of HBAs, the number of CPUs, the memory capacity, and the number of drives corresponding to the selected storage partition size are transmitted from the storage 120 to the run book automation program 660, and the run book automation program 660 registers the IDs, the inputted storage partition ID, and the inputted environment name (actual or development environment) in the entries corresponding to the target storage partition (entries in storage partition table 155).

The storage HBA 121 and the CPU 123 may be determined in (1400-1), (1400-2), or any other step. For example, the run book automation program 660 may transmit an instruction associated with the number of HBAs and the number of CPUs corresponding to the selected storage partition size (for example, RAID group creation instruction, CLPR creation instruction, or any other instruction) to the storage 120. In response to the instruction, the storage 120 may determine the HBA 121 and the CPU 123 to be contained in the target storage partition in accordance with the number of HBAs and the number of CPUs associated with the instruction.

The storage partition creation process described above may be carried out in an integrated LPAR creation process. In the present embodiment, however, the storage partition creation process is carried out before the integrated LPAR creation process. In other words, after the storage partition creation process, the integrated LPAR creation process starts. In the storage partition creation process, a large load process accompanied by data transfer between drives 125 is required in some cases, and when an attempt to create a storage partition is made in the integrated LPAR creation process, a long time is likely to be required from the start of the integrated LPAR creation process to the end thereof. It can therefore be expected that the time required for the integrated LPAR creation process is shortened by carrying out the storage partition creation process first.

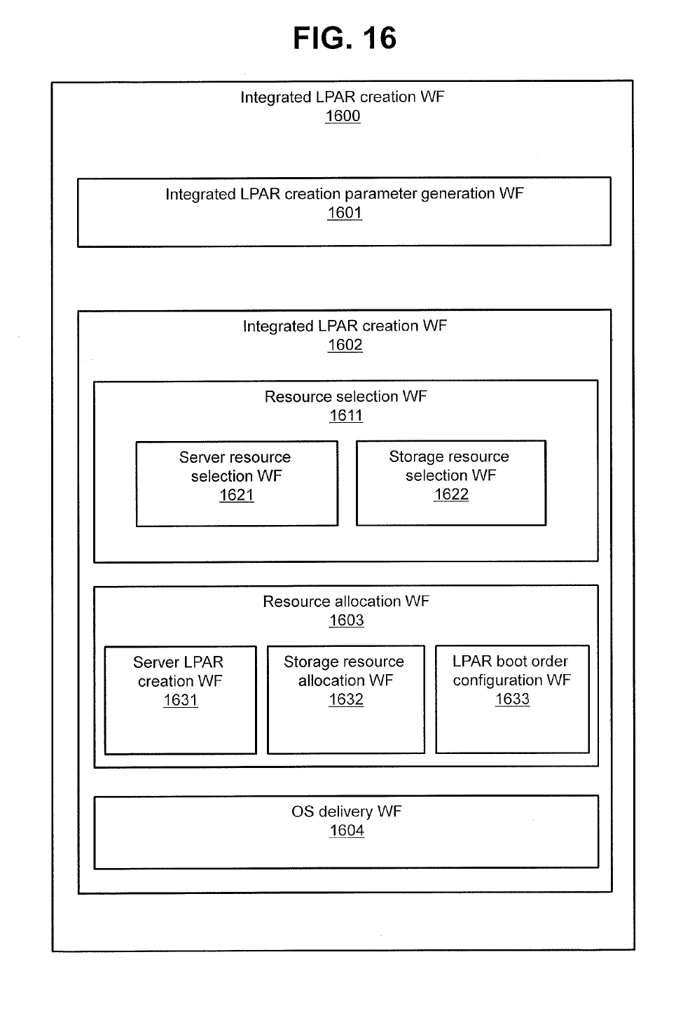

An integrated LPAR creation overall process carried out in response to the integrated LPAR creation instruction accepted by the run book automation program 660 via the integrated LPAR creation screen 141 is a process carried out by execution of an integrated LPAR creation overall workflow (WF) shown in FIGS. 16 and 17. The integrated LPAR creation overall WF will be described below.

FIG. 16 shows an example of the configuration of the integrated LPAR creation overall WF. FIG. 17 shows the relationship among components (WF) of an integrated LPAR creation WF in the integrated LPAR creation overall WF. In FIG. 17, the arrow from a first WF to a second WF means that the first WF is carried out and then the second WF is carried out.

The integrated LPAR creation overall WF 1600 is formed of an integrated LPAR creation parameter generation WF 1601, which is executed by the integrated LPAR creation parameter generation function 173 (FIG. 1), and an integrated LPAR creation WF 1602, which is executed by the integrated LPAR creation function 144.

The integrated LPAR creation parameter generation WF 1601 is a WF so defined as to acquire, on the basis of the one or more types of load characteristic information (APP name, APP intended use, environment type, and integrated LPAR size according to example in FIG. 15) associated with the integrated LPAR creation instruction and the allocation control information 672, parameters necessary for creation of an integrated LPAR to which the integrated LPAR ID inputted to the screen 141 is allocated. The integrated LPAR creation parameter generation WF 1601 may be a component of the integrated LPAR creation WF 1602. In the present embodiment, however, the integrated LPAR creation parameter generation WF 1601 is a component of the overall WF 1600 but is not a component of the integrated LPAR creation WF 1602. It is expected that separating the integrated LPAR creation parameter generation WF 1601 from the integrated LPAR creation WF 1602 allows, even when a user (tenant manager, for example) issues a variety of requests in association with the LPAR creation instruction, flexible handling of the requests.

The integrated LPAR creation WF 1602 is a WF so defined as to create an integrated LPAR in accordance with parameters acquired by execution of the integrated LPAR creation parameter generation WF 1601. In WF 1601, divided processes are defined. Specifically, for example, in WF 1601, a process relating to the server 100 and a process relating to the storage 120 are distinguished from each other. The integrated LPAR creation WF 1602 is formed of a resource selection WF 1611, which is executed by the resource selection function 191 (FIG. 1), a resource allocation WF 1612, which is executed by the resource allocation function 192, and an OS delivery WF 1613, which is executed by the OS delivery function 193. The resource selection WF 1611 is formed of a server resource selection WF 1621, which is so defined as to select server resources, and a storage resource selection WF 1622, which is so defined as to select storage resources. The resource allocation WF 1612 is formed of a server LPAR creation WF 1631, which is so defined as to create a server LPAR, a storage resource allocation WF 1632, which is so defined as to allocate storage resources, and an LPAR boot order configuration WF 1633, which is so defined as to configure a boot order.

The process as the execution of a WF may be applied to the storage partition creation process. Each WF may be provided as a service based, for example, on the mechanism described below. Further, an example of the “user” in the following description may be a manager. An example of the “operation automation program” in the following description may be any of the integration management server 140, the run book automation program 660, and another program in the integration management server 140.

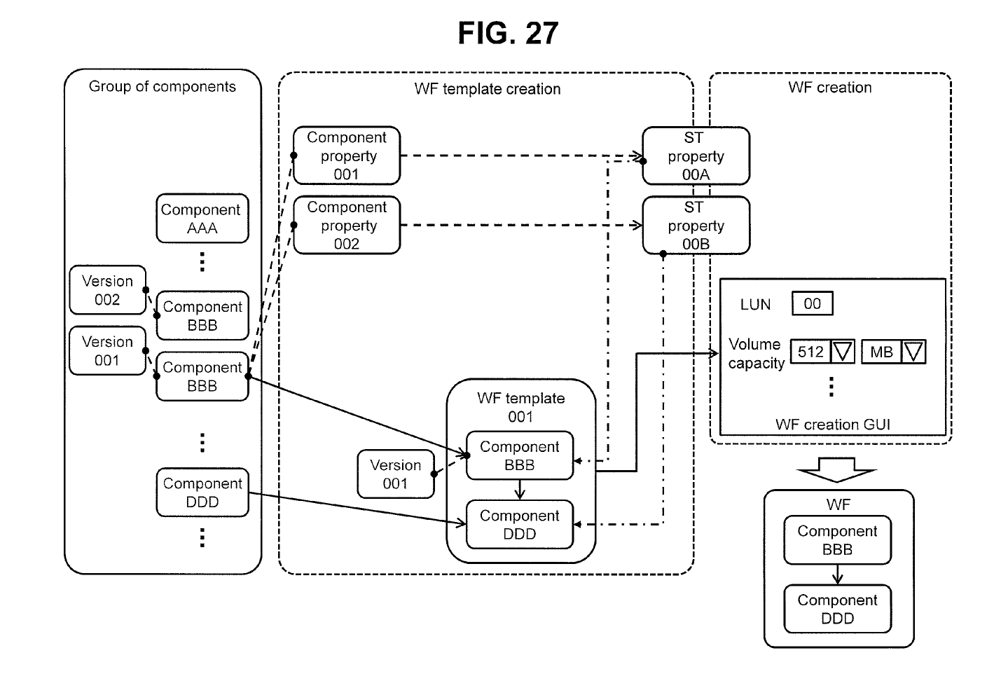

FIG. 27 is a diagrammatic view of an overview of an example of providing a WF.

An operation automation system manages a large number of components (group of components) for system operation. The term “system operation” used herein is operation of the server storage system 1000. The term “component” is part of the system operation and is a single independent process (task). The component is one unit associated with a WF template (one unit contained in WF template). Examples of the component include a plugin component and a WF template component (the latter is a WF template handled as a component). The plugin component is, for example, a process module that executes a script and may be an executable file. In the present embodiment, a WF template is created on the basis of two or more components, a WF is created on the basis of the created WF template, and the created WF is executed. Overviews of component management, WF template creation, WF template finalization, WF creation, and WF execution will be described below.

<Component Management>

A component may be added or changed by a component providing user. The operation automation system manages, on a component basis, one or more component properties associated with the component. The operation automation system further manages, on a component basis, the version of the component. FIG. 27 shows the component properties and the version of a component BBB by way of example, and it is noted that another component also has component properties and a version associated with the component.

The “component properties” are properties of a component. The component properties include two types of property, a component input property and a component output property. The component input property is a property relating to input of a value of a defined item (display name), and the component output property is a property relating to output of the value of the defined item (display name). One component has at least one of one or more component input properties and zero or more component output properties associated with the component. That is, the number of output properties is zero in some cases depending on a component, but one or more input properties are associated with each component. The input value may, for example, be a copy of a value inputted as a property of a WF created in the past or a copy of a value outputted in relation to another component having been executed. The output value may, for example, be configuration information after a component is executed.

The “component providing user” is a user who uses the operation automation system and adds, updates, or otherwise handles a component. The component providing user can create, add, update, or otherwise handle a component via a GUI (graphical user interface), a CLI (command line interface), an API (application programming interface), or any other interface. A component added or updated by the component providing user may typically be a plugin component. A plugin component and a WF template component can both be associated with a WF template. A plugin component may be formed of a minimum unit, and a WF template component may be a package of one or more plugin components and a WF template with which the plugin components are associated. A plugin component may contain a component input property and the content of a process to be carried out on the basis of an input value inputted as the component input property. A WF template component may similarly contain a component input property and the content of a process to be carried out on the basis of an input value inputted as the component input property. The component input property of a WF template component may be a WF template input property.

<WF Template Creation>

The operation automation system displays a WF template creation screen. The WF template creation screen displays an information input UI. A WF template creating user inputs information to the WF template creation screen. For example, the operation automation system accepts selection of two or more of a large number of components and specification of the execution order of the two or more components via the WF template creation screen. The operation automation system creates a component-flow WF template on the basis of the selected two or more components and the specified execution order.

The “WF template creating user” is a user who uses the operation automation system and creates a WF template. The WF template creating user may be the component providing user or may be a different person.

The “WF template” is a template of WFs. It can also be said that the WF template is an OBJECT specifying a non-instantiated automatically executed content.

The “component flow” is typically a train of two or more selected components. The train of components follows a specified execution order. In a case where the number of selected components is one, the number of components that form the component flow is also one.

As described above, the operation automation system creates a WF template on the basis of two or more components selected via the WF template creation screen and the execution order specified via the WF template creation screen, as described above. Specifically, for example, the operation automation system creates a plurality of WF template properties corresponding to a plurality of component properties associated with the two or more selected components and associates the created plurality of WF template properties with the WF template. The WF template properties corresponding to the component properties are automatically created by the operation automation system on the basis of the component properties. The “WF template properties” are properties of a WF template. The WF template properties include two types of properties, a WF template input property and a WF template output property. The WF template input property is a property relating to input of a value of a defined item (display name), and the WF template output property is a property relating to output of the value of the defined item (display name). One WF template has at least one of one or more WF template input properties and zero or more WF template output properties related to the WF template. That is, one WF template output property is not necessarily always present.

<WF Creation>

The operation automation system receives selection of one of created WF templates from the WF creating user and displays a WF creation screen on the basis of the selected WF template. The WF creating user inputs information to the WF creation screen. The operation automation system creates a WF on the basis of the information inputted via the WF creation screen.

The “WF creating user” is a user who creates (executes) a WF. The WF creating user and the WF template creating user may be different users or may be the same user.

The term “WF” is an instantiated WF template. Specifically, a WF template has values necessary for execution of the WF replaced with blank values, and necessary values are inputted to the WF template to form the WF. The above-mentioned values necessary for execution of a WF can be configured in some cases by default values as information on the properties of the WF template.

Overviews of the component management, the WF template creation, and the WF creation have been described above.

Examples of WFs provided in according with the above-mentioned method for providing a WF are WFs 1601, 1602, 1611, 1612, 1613, 1621, 1622, 1631, 1632, and 1633 in FIG. 16. The procedure of a process as execution of the WFs will be described below.

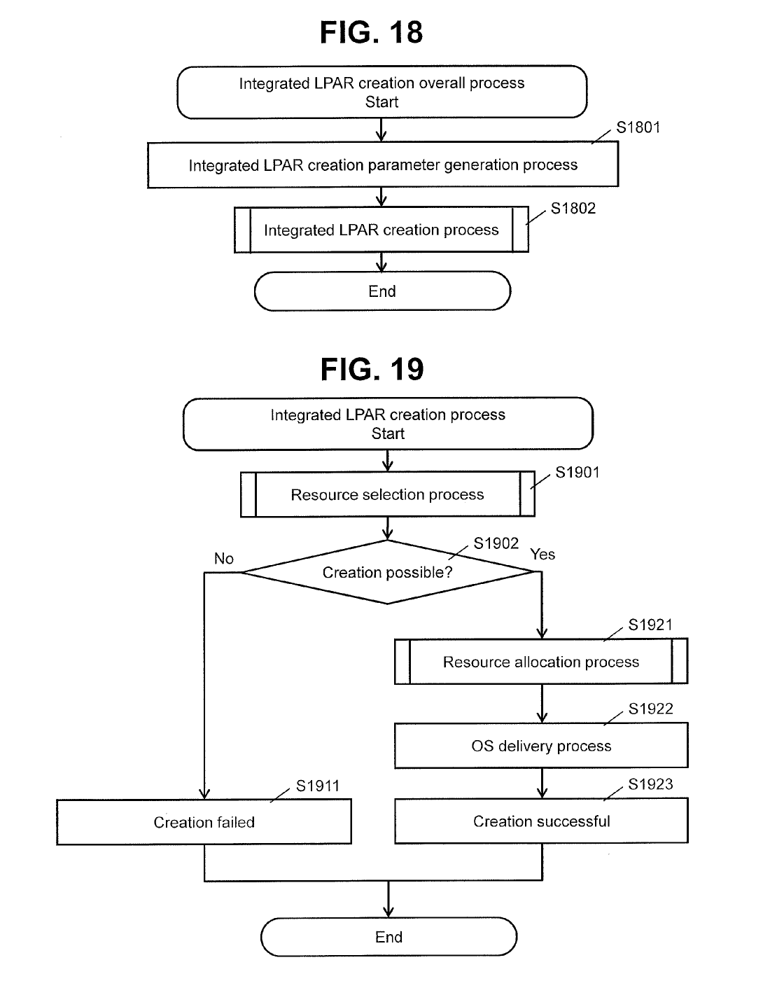

FIG. 18 shows the procedure of the integrated LPAR creation overall process.

The integrated LPAR creation overall process is a process carried out in response to the integrated LPAR creation instruction (instruction with which inputted integrated LPAR ID, APP name, APP intended use, environment type, and integrated LPAR size are associated) accepted via the integrated LPAR creation screen 141 and is also a process carried out by execution of the integrated LPAR creation overall WF 1600.

The integrated LPAR creation parameter generation function 173 executes the integrated LPAR creation parameter generation WF 1601, that is, an integrated LPAR creation parameter generation process (S1801). Specifically, the integrated LPAR creation parameter generation function 173 acquires parameters from the allocation control information 672 by using keys formed of the APP name, the APP intended use, the environment type, and the integrated LPAR size associated with the integrated LPAR creation instruction.

The integrated LPAR creation function 144 then executes the integrated LPAR creation WF 1602, that is, the integrated LPAR creation process (S1802). In the description, the integrated LPAR creation function 144 uses the parameters acquired (generated) in S1801 as an input to select server resources and storage resources and allocates the selected server resources and storage resources to create an integrated LPAR.

FIG. 19 shows the procedure of the integrated LPAR creation process.

The resource selection function 191 executes the resource selection WF 1611, that is, a resource selection process (S1901). In the description, the resource selection function 191 uses the parameters acquired (generated) in S1801 as an input.

In a case where it is impossible to secure resources necessary for creation of the integrated LPAR (No in S1902), it is determined that the integrated LPAR cannot be created and the resource selection process is terminated (S1911). For example, the integrated LPAR creation function 144 notifies the source from which the integrated LPAR creation instruction has been transmitted (tenant manager or system manager, for example) of the failure of creation of the integrated LPAR.

In a case where the necessary resources are secured (Yes in S1902), the resource allocation function 192 executes the resource allocation WF 1612, that is, a resource allocation process (1921). In the description, the resource allocation function 192 uses information on the secured resources as an input to create the integrated LPAR. The OS delivery function 193 then executes the OS delivery WF 1613, that is, an OS delivery process (S1922). Specifically, for example, the OS delivery function 193 delivers an activation image (OS image) prepared in accordance with the APP name and the APP intended use of an APP executed in the created LPAR (APP name and APP intended use inputted to screen 141). The integrated LPAR creation function 144 then notifies the source from which the integrated LPAR creation instruction has been transmitted (tenant manager or system manager, for example) of the success of creation of the integrated LPAR (S1923).

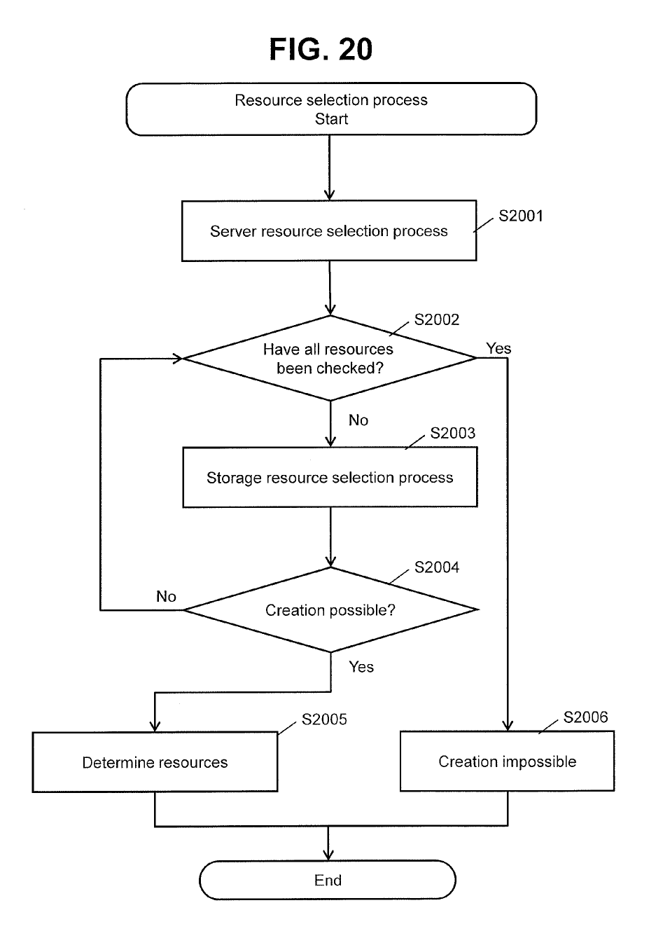

FIG. 20 shows the procedure of the resource selection process. In FIG. 20, S2001 represents execution of the server resource selection WF 1621, and S2002 to S2006 represent execution of the storage resource selection WF 1622.

The resource selection function 191 uses the inputted parameters (parameters acquired (generated) in S1801) to carry out a server resource selection process (S2001). In the description, the resource selection function 191 identifies all candidates of combinations of the server resource (hereinafter referred to as server resource combination candidates) relevant to the inputted parameters (useable to create integrated LPAR). In a case where a plurality of server resource combination candidates are present, priority is assigned to each of the server resource combination candidates on the basis of the server resources use situations and other factors. For example, higher priority is assigned to a server resource combination candidate with a lower load as the use situation.

In S2002, the resource selection function 191 selects a server resource combination candidate having the highest priority from unselected server resource combination candidates (S2002). In a case where no unselected server resource combination candidate is present, the resource selection function 191 determines that the integrated LPAR cannot be created and terminates the resource selection process (S2006). In a case where S2006 is carried out, the result of S1902 shows No and S1911 is carried out in FIG. 19.

The resource selection function 191 searches the storage 120 coupled (physically coupled) to the server resource combination candidate selected in S2002 for securable, necessary storage resources (S2003). The server resource combination candidate is, for example, a server resource combination in the same server 100. The storage 120 coupled to the server resource combination candidate can be identified from the server/storage coupling table 154. The “necessary storage resources” are storage resources that accord with the resource type, the resource quantity, and the allocation type identified from the allocation control information 672 by using the inputted parameters and may be searched for, for example, from the storage HBA table 153 and the storage partition table 155.

In a case where no storage resource is found in S2003 (No in S2004), the resource selection function 191 returns to S2002. For example, in a case where two exclusively allocatable HBA ports need to be present in the storage 120 coupled to the server resource combination candidate selected in S2002, but the two HBA ports have been already commonly allocated, which means that no storage resource has been found, S2002 is, as a result, carried out again.

In a case where storage resources are found in S2003 (Yes in S2004), the resource selection function 191 determines the server resource combination candidate selected in S2002 as selected server resources and determines the storage resources found in S2003 as selected storage resources (S2005).

According to the resource selection process in FIG. 20, after server resources and storage resources are both selected, the resource selection process is terminated, and the resource allocation process is then carried out. After at least one server resource combination candidate, but before storage resources for the server resource combination candidate are found, searching for necessary storage resources after allocation of the server resource may result in a situation in which no necessary storage resource is found from the storage 120 coupled to the server resource. This may particularly happen in a case where only part of the storages 120 is coupled to the server 100 having the selected server resource. Once a server resource is exclusively allocated, the server resource cannot be exclusively allocated to another integrated LPAR unless the exclusive allocation is released. The overall time necessary for the integrated LPAR creation process therefore increases. In the present embodiment, in which the resource allocation process is carried out after a server resource and a storage resource are both selected, the problem described above can be avoided.

In the present embodiment, the correspondence between the server HBA ports 108 and the storage HBA ports 122 is 1:1. Instead, the servers 100 and the storages 120 may be coupled to each other via switches to allow the correspondence between the server HBA ports 108 and the storage HBA ports 122 to be 1:n, m:1, or m:n (n and m are each an integer equal to 2 or larger).

FIG. 21 shows the procedure of the resource allocation process. In FIG. 21, S2101 is execution of the server LPAR creation WF 1631, S2102 is execution of the storage resource allocation WF 1632, and S2103 is execution of the LPAR boot order configuration WF 1633.

The resource allocation function 192 carries out a server LPAR creation process (S2101) on the basis of information on the server resources selected in the resource selection process (information acquired from management information 670, for example).

The resource allocation function 192 carries out a storage resource allocation process (S2102) on the basis of information on the storage resources selected in the resource selection process (information acquired from management information 670, for example).

The integrated LPAR is created by S2101 and S2102, and the resource allocation function 192 configures a boot order for the created integrated LPAR (S2103). In this process, for example, a boot order for booting from a VOL (data VOL) in which the activation image (OS image) is stored is configured. The boot order may be defined, for example, in a script file, and configuring the script file in the integrated LPAR may be the boot order configuration.

FIG. 22 shows the procedure of the server LPAR creation process.

The resource allocation function 192 performs server LPAR creation, specifically, server CPU allocation (S2201), server memory allocation (S2202), server NIC (port, for example) allocation (S2203), and server HBA port allocation (2204). The server resources allocated in S2201 to S2204 are server resources selected in the resource selection process. After the allocation is completed, whether the allocated server resources have been exclusively or commonly allocated may be associated with relevant tables in the management information 670. The exclusively allocated server resources are not allocated to an integrated LPAR different from the created integrated LPAR.

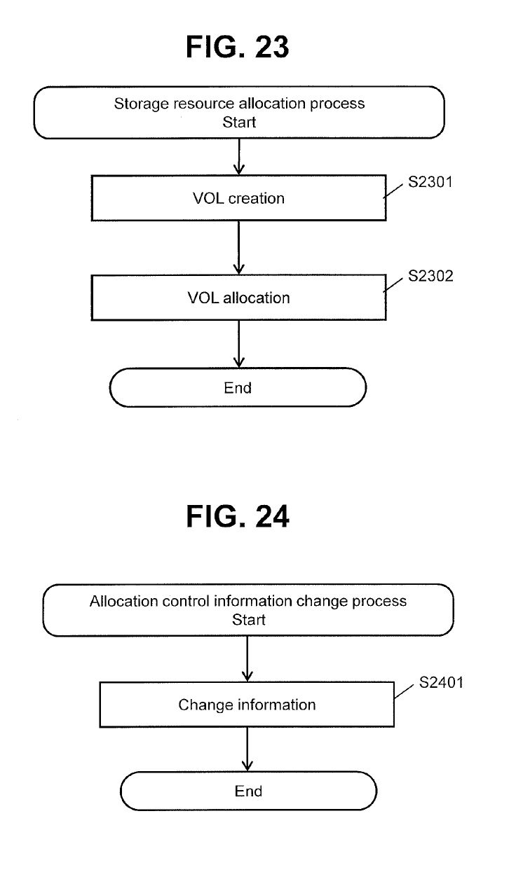

FIG. 23 shows the procedure of the storage resource allocation process.

The resource allocation function 192 performs VOL creation (S2301). In this process, for example, the resource allocation function 192 creates, from the storage partition in the storage resources selected in the resource selection process, VOLs the capacity of which and the number of which have been identified in the resource selection process.

The resource allocation function 192 allocates (provides) all the VOLs created in S2301 to the created integrated LPAR (S2302). The integrated LPAR (server LPAR, in particular) therefore recognizes the VOLs created in S2301. In S2302, the resource allocation function 192 may exclusively or commonly allocate the storage resources (storage HBA ports, for example) selected in the resource selection process.

The integrated LPAR creation overall process has been described above.

A specific example of the integrated LPAR creation overall process will be described below.

<Integrated LPAR Creation Parameter Generation Process>

It is assumed that the following information has been inputted to the integrated LPAR creation screen 141 in FIG. 15.

(+) APP name=APP-a

(+) APP intended use=OLTP

(+) Environment=Actual environment

(+) Integrated LPAR size=S

In S1801, the integrated LPAR creation parameter generation function 173 refers to the I/O size table 145 in FIG. 3 to acquire the VOL intended use 303 and the I/O size 304 corresponding to the inputted APP name “APP-a” and APP intended use “OLTP.” In the description, the I/O size “large” is acquired for the VOL intended use “data” (data VOL), and the I/O size “small” is acquired for the VOL intended use “log” (log VOL).

Further, in S1801, the integrated LPAR creation parameter generation function 173 acquires information on the integrated LPAR from the integrated LPAR size template table 147 in FIG. 5. In the description, the number of LPAR CPU cores of “8”, the LPAR memory capacity of “128 GB,” and the number of LPAR NIC ports of “1” corresponding to the inputted integrated LPAR size “S” are acquired. Further, the number of HBA ports of “2” and the number of server HBA CTLs of “4” are acquired for the I/O size “large” (data VOL). The number of HBA ports of “2” and the number of server HBA CTLs of “2” are acquired for the I/O size “small” (log VOL).

Further, in S1801, the integrated LPAR creation parameter generation function 173 acquires the VOL capacity 605 and the number of VOLs 606 from the VOL template table 148 in FIG. 6. In the description, the VOL capacity of “128 GB” and the number of VOLs of “4” corresponding to the inputted APP name “APP-a,” APP intended use “OLTP,” and integrated LPAR size “S” are acquired for the VOL intended use “data” (data VOL). The VOL capacity of “128 MB” and the number of VOLs of “4” corresponding to the inputted APP name “APP-a,” APP intended use “OLTP,” and integrated LPAR size “S” are also acquired for the VOL intended use “log” (log VOL).

Further, in S1801, the integrated LPAR creation parameter generation function 173 acquires the HBA 1303, the CPU 1304, the memory 1305, and the drive 1306 corresponding to a selected storage partition from the storage partition table 155 in FIG. 13. In the description, the HBAs “HBA1” and “HBA2,” the CPUs “CPU1” and “CPU2,” the memories “CLPR1” and “CLPR2,” and the drives “Drive 1 to Drive 8” corresponding to the inputted environment “actual environment” are acquired.

Further, in S1801, the integrated LPAR creation parameter generation function 173 acquires information on the HBA of the coupled server from the server/storage coupling table 154 in FIG. 12. In the description, the server HBA ports “Port-a,” “Port-b,” “Port-c,” and “Port-d” of the server HBA “HBA-a” corresponding to the storage HBAs “HBA1” and “HBA2” are acquired.

Further, in S1801, the integrated LPAR creation parameter generation function 173 identifies the allocation type of each of the resource types for the identified I/O sizes “small” and “large” from the allocation policy table 146 in FIG. 4. For example, “exclusive” is identified as the allocation type of the server HBA port for the I/O size “large” (data VOL).

The information having been acquired in the above processes is as follows.

<Server LPAR Information (Parameters Relating to Server Resources)>

(+) Number of CPU cores=8

(+) Memory capacity=128 GB

(+) Number of NIC ports=1

(+) Information on server HBA for data VOL=Number of ports of “2”, number of CTLs of “4”, and allocation type “port exclusively used”

(+) Information on server HBA for log VOL=Number of ports of “2”, number of CTLs of “2”, and allocation type “CTL exclusively used”

(+) Useable server HBA port=“Port-a,” “Port-b”, “Port-c,” and “Port-d” of “HBA-a”

<Storage Configuration Information (Parameters Relating to Storage Resources)>

(+) Drive information=Drive 1 to Drive 8

(+) Data VOL=VOL capacity of “128 GB,” number of VOLs of “4”, and allocation type “CPU exclusively used, memory exclusively used”

(+) Log VOL=VOL capacity of “128 GB,” number of VOLs of “4”, and allocation type “CPU commonly used, memory commonly used”

(+) Useable CPU=CPU 1, CPU 2

(+) Useable memory=CLPR 1, CLPR 2

(+) Useable storage HBA=HBA 1, HBA 2

These parameters are inputted to the integrated LPAR creation WF 1602.

<Resource Selection Process (S1901) in Integrated LPAR Creation Process>

The resource selection function 191 acquires a list of prioritized, useable server resource combination candidates. The resource selection function 191 carries out the storage resource selection process until corresponding storage resources are found to uniquely determine server resources and storage resources to be eventually used.

<<Server Resource Selection Process (S2001)>>

The following parameters are inputted to the server resource selection WF 1621.

(+) Number of CPU cores=8

(+) Memory capacity=128 GB

(+) Number of NIC ports=1

(+) Information on server HBA for data VOL=Number of ports of “2”, number of CTLs of “4”, and allocation type “port exclusively used”

(+) Information on server HBA for log VOL=Number of ports of “2”, number of CTLs of “2”, and allocation type “CTL exclusively used”

(+) Useable server HBA port=“Port-a,” “Port-b”, “Port-c,” and “Port-d” of “HBA-a”

The resource selection function 191 refers to server configuration information that is not shown in the management information 670. The server configuration information may contain the server resource type, the server resource quantity, the relationship between the server resource quantity and the allocation state (exclusive allocation, common allocation, no allocation, for example), and other factors for each of the servers 100. The server configuration information may contain the server HBA table 152. The resource selection function 191 prioritizes, on the basis of the input described above and the server configuration information, a combination that allows server resources relevant to the input described above to be secured and returns the prioritized combination. The prioritization may be performed on the basis of a certain policy, such as a resource idle state. As a result, the following parameters are outputted (“(++P)” means parameter that belongs to “(+P)”).

(+P) Configuration name=Configuration idea 1

(++P) ID of server to be used=Server A

(++P) Number of CPU cores=8

(++P) Memory capacity=128 GB

(++P) NIC port=“Port-x” of “NIC-a”

(++P) Information on server HBA for data VOL=Port-a (exclusive allocation), Port-b (exclusive allocation)

(*) Information on Server HBA for log VOL=Port-c (common allocation), Port-d (common allocation)

(++P) Priority=1

<<Storage Resource Selection Process (S2003)>>

The following parameters are inputted as the parameters relating to the storage resources coupled to “server A,” which is the ID of the server to be used, to the storage resource selection WF 1622.

(+) Drive information=Drive 1 to Drive 8

(+) Data VOL=VOL capacity of “128 GB,” number of VOLs of “4”, and allocation type “CPU exclusively used, memory exclusively used”

(+) Log VOL=VOL capacity of “128 MB,” number of VOLs of “4”, and allocation type “CPU commonly used, memory commonly used”

(+) Useable CPU=CPU 1, CPU 2

(+) Useable memory=CLPR 1, CLPR 2

(+) Useable storage HBA=HBA 1, HBA 2

The resource selection function 191 refers to the storage configuration information that is not shown in the management information 670. The storage configuration information may contain the storage resource type, the storage resource quantity, the relationship between the storage resource quantity and the allocation state (exclusive allocation, common allocation, no allocation, for example), and other factors for each of the storages 120. The storage configuration information may contain the storage HBA table 153 and the storage partition table 155. The resource selection function 191 determines, on the basis of the input described above and the storage configuration information, storage resources relevant to the input described above and returns, for example, the output parameters described below. In a case where no storage resource can be secured, a message stating that no storage resource can be secured is returned.

(+Q) VOL type=Data VOL

(++Q) VOL capacity=128 GB

(++Q) Number of VOLs=4

(++Q) CPU ID/allocation type=CPU 1/exclusive allocation

(++Q) Memory ID/allocation type=CLPR 1/exclusive allocation

(++Q) HBA for data VOL=HBA 1

(++Q) Storage pool to be used=Pool 1

(+R) VOL type=Log VOL

(++R) VOL capacity=128 MB

(++R) Number of VOLs=4

(++R) CPU ID/allocation type=CPU 2/common allocation

(++R) Memory ID/allocation type=CLPR 2/common allocation

(++R) HBA for data VOL=HBA 2

(++R) Storage pool to be used=Pool 2

<Resource Allocation Process (S1921)>

The resource allocation function 192 performs the server LPAR creation and the storage resource allocation on the basis of the information obtained from the resource selection process.

<<Server LPAR Creation Process (S2101)>>

The following parameters are inputted to the server LPAR creation WF 1631.

ID of selected server=Server A

CPU core (or number of core)=Core 1-8

Memory capacity=128 GB

NIC port=“Port-x” of “NIC-a”

Information on server HBA for data VOL=Port-a (exclusive allocation), Port-b (exclusive allocation)

Information on server HBA for log VOL=Port-c (common allocation), Port-d (common allocation)

<<Storage Resource Allocation Process (S2102)>>

VOLs according to the VOL intended use are created and allocated (provided) to the integrated LPAR (server LPAR). Specifically, for example, S2102 may contain creation of VOLs, creation of a host group, registration of the VOLs to the host group, and allocation (provision) of the host group to the integrated LPAR. The following parameters are inputted to the storage resource allocation WF 1632.

(+S) VOL type=Data VOL

(++S) VOL capacity=128 GB

(++S) Number of VOLs=4

(++S) CPU ID/allocation type=CPU 1/exclusive allocation

(++S) Memory ID/allocation type=CLPR 1/exclusive allocation

(++S) HBA for data VOL=HBA 1

(++S) Server HBA port information=WWN (World Wide Name) “xxx” of “Port-a,” WWN “yyy” of “Port-b”

(++S) Storage pool to be used=Pool 1

(+T) VOL type=Log VOL

(++T) VOL capacity=128 MB

(++T) Number of VOLs=4

(++T) CPU ID/allocation type=CPU 2/common allocation

(++T) Memory ID/allocation type=CLPR 2/common allocation

(++T) HBA for data VOL=HBA 2

(++T) Server HBA port information=WWN “ggg” of “Port-c,” WWN “kkk” of “Port-d”

(++T) Storage pool to be used=Pool 2

The parameters described below are outputted in response to the input described above. The parameters described below are UUIDs (Universally Unique Identifiers) of the data VOL used at the time of OS delivery. In a case where a plurality of data VOLs are present, a data VOL selected by the resource allocation function 192 from the plurality of data VOLs may be used as a boot VOL (data VOL used for booting).

(+) UUID=UUID of boot VOL

(+) LUN=LUN of boot VOL

<LPAR Boot Order Configuration Process (S2103)>

The resource allocation function 192 creates a configuration that allows the created integrated LPAR to be activated from the boot VOL. As the configuration, the parameters described below are inputted to the boot order configuration WF 1633, and the parameters are configured in the integrated LPAR in the LPAR boot order configuration process.

(+) WWN of storage HBA coupled to boot VOL=WWN of “HBA 1”

(+) LUN (Logical Unit Number)=LUN of boot VOL

<OS Delivery Process (S1922)>

The OS delivery function 193 delivers a master image of the inputted APP name and APP intended use to the created integrated LPAR. In this process, the OS delivery function 193 may automatically configure information for the OS (information containing link to activation image, for example) and information for the APP (information containing link to APP image, for example) in the integrated LPAR. The OS delivery process may be an optional process (OS delivery process may not be necessarily carried out). For example, the following information may be inputted to the OS delivery WF 1613.

(+) Image to be used=Master image of “APP-a”

(+) UUID=UUID of boot VOL

A specific example of the integrated LPAR creation overall process has been described above.

In the integrated LPAR creation overall process, each of the WFs is executed, and the allocation control information is referred to when at least one of the WFs is executed. In the present embodiment, WFs and the allocation control information can both be changed. In the present embodiment, the run book automation program 660 controls operation that the run book automation program 660 permits a change requesting user in accordance with the user type, such as whether the change requesting user is a tenant manager or the system manager. An example of the control will be described below in detail.

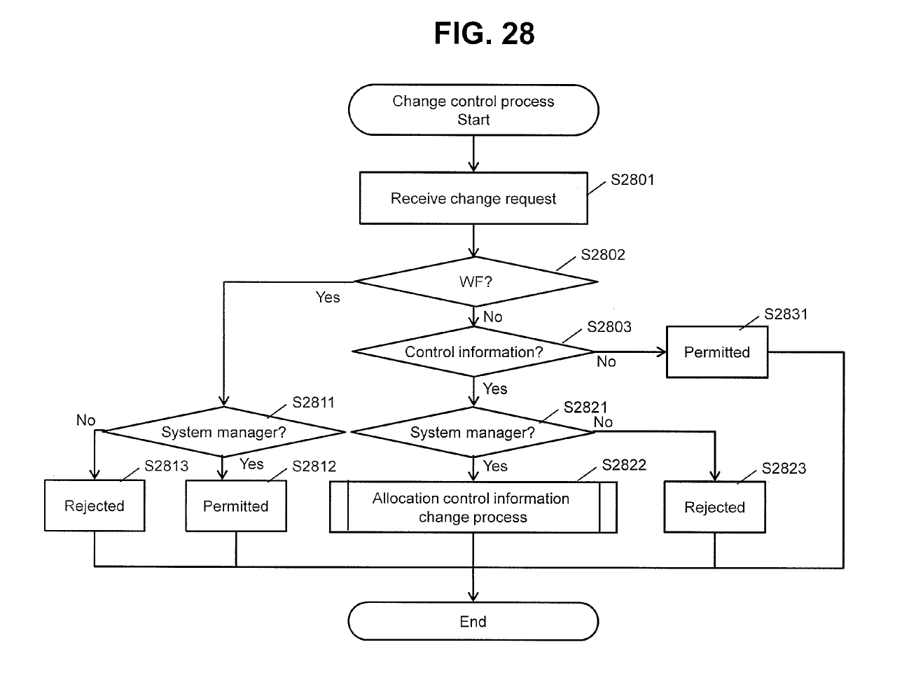

FIG. 28 shows the procedure of a change control process. The change control process may be a process carried out by execution of a predetermined WF.

The run book automation program 660 receives a change request (S2801). Information representing a target to be changed is associated with the change request, and the run book automation program 660 can identify the target to be changed on the basis of the information. Further, the run book automation program 660 can identify the user type, such as whether the change requesting user is a tenant manager or the system manager. The user type may be identified on the basis of user information associated with the received change request or may be identified in advance, for example, by login operation before the change request reception.

In a case where the target to be changed is a WF (Yes in S2802), the run book automation program 660 permits a change in the WF in accordance with the change request (S2812) when the change requesting user is the system manager (Yes in S2811). For example, the run book automation program 660 replies that the change is permitted to the system manager and changes the WF in accordance with the change request. On the other hand, when the change requesting user is a tenant manager (No in S2811), the run book automation program 660 rejects the change request (S2812). For example, the run book automation program 660 replies that the change is not permitted to the tenant manager.

In a case where the target to be changed is at least part of the allocation control information 672 (No in S2802, Yes in S2803), the run book automation program 660 permits a change in the target to be changed in accordance with the change request (S2822) when the change requesting user is the system manager (Yes in S2821). Specifically, for example, the run book automation program 660 replies that the change is permitted to the system manager and executes an allocation control information change WF to carry out an allocation control information change process (which will be described later in detail with reference to FIG. 24). In this process, the target to be changed may, for example, be any of the integrated LPAR size template table 147 (FIG. 5), the storage partition size template table (see reference character 1403 in FIG. 14), and the allocation policy table 146 (FIG. 4). On the other hand, when the change requesting user is a tenant manager (No in S2821), the run book automation program 660 rejects the change request (S2822). For example, the run book automation program 660 replies that the change is not permitted to the tenant manager.

In a case where the target to be changed is neither a WF nor at least part of the allocation control information 672 (No in S2802, No in S2803), the run book automation program 660 permits the change according to the change request (S2831).

FIG. 24 shows the procedure of the allocation control information change process.

The resource allocation control change function 196 of the run book automation program 660 carries out S2401. In S2401, the resource allocation control change function 196 changes a target to be changed in the allocation control information 672 (for example, configuration file that defines specified table in allocation control information 672). As a result, the integrated LPAR creation policy defined by the allocation control information 672 is changed. That is, even when the same parameters are inputted to the integrated LPAR creation screen 141 (or 162), the configuration of a created integrated LPAR (at least one of allocation type, resource type, and resource quantity) before the change differs from the configuration after the change.

The configuration file can be changed by using a GUI and a command provided by an APP or can be directly changed. Only the system manager can carry out the process of changing the configuration file, as described above. In the case where a GUI or a command is used, the function of checking if a change executing user has the authority limits a user who can change the configuration file to the system manager, whereas in the case where the file is directly changed, the access authority, for example, limits the user who can change the file to the system manager.

An example of the change control process has been described.

According to the present embodiment, a WF and the allocation control information 672 are both changeable. Therefore, for example, at least one of an APP vender, a management server vender, a system engineer, and others can examine the best combination of an APP, server resources, and storage resources and create a template of the best combination to flexibly handle a new APP (added or upgraded APP, for example). It is expected that the handling can be achieved by changing at least part of the allocation control information 672 and at least part of the integrated LPAR creation parameter generation WF. The change in at least part of the allocation control information 672 may be performed, for example, by adding a new correspondence among the resource types and resource quantities of exclusively allocated server resources and storage resources, the resource types and resource quantities of commonly allocated server resources and storage resources, and the LPAR load characteristics to the allocation control information.

Further, according to the present embodiment, the integrated LPAR creation overall process is carried out by execution of changeable (editable) WFs, but only the system manager is permitted to change a WF involved in the integrated LPAR creation overall process. It is in general believed that the amount of a tenant manager's technical knowledge is smaller than the system manager's, and if such a tenant manager changes a WF involved in creation of an integrated LPAR, there is a possibility of occurrence of an error in the creation of the integrated LPAR requested by the tenant manager. According to the present embodiment, such a possibility can be reduced.

Further, according to the present embodiment, only the system manager is again permitted to change the allocation control information 672. If a tenant manager is permitted to change the allocation control information 672, the tenant manager can change, for example, the allocation type “commonly used” in the allocation policy table 146 to “exclusively used.” In this situation, shortage of resources may undesirably occur in a resource balanced state unintended by the server storage system 1000 (for example, as opposed to an initial expectation that shortage of the HBA CTLs 107 and shortage of the CPUs 123 of the storage 120 occur at the same time, the shortage of the HBA CTLs 107 occurs much earlier than expected). In the present embodiment, such a possibility can be reduced.

The system manager may give a tenant manager at least one of authority to change a WF involved in creation of an integrated LPAR for the tenant corresponding to the tenant manager and authority to change an integrated LPAR creation policy for the tenant corresponding to the tenant manager. In this case, the “system manager” in at least one of S2811 and S2821 includes not only the system manager but a tenant manager who is given a right from the system manager. The integrated LPAR creation policy (allocation control information 672) may be common to the tenants in the entire server storage system 1000 or may be independently present on a tenant basis. In the latter case, a WF involved in the integrated LPAR creation overall process may be present on a tenant basis. The configuration file (table) referred to when the WF is executed may be changed. Specifically, for example, different integrated LPAR creation parameter generation WFs 1601 may be prepared on a tenant basis, or a table referred to when an integrated LPAR creation parameter generation WF 1601 common to a plurality of tenants is executed may be changed.

When at least one of the allocation control information 672 and a WF is changed, the following use cases, for example, are conceivable:

### <Use Case 1: Adjustment of Balance Among Resources>

In an environment in which the number of server resources is fewer than the number of storage resources, and in a case where a newly created system has low performance KPI (Key Performance Indicator), it is expected that shortage of server resources is avoided by reducing the resource quantity of the CPU/memory in a server LPAR for a target APP.

### <Use Case 2: Addition or Upgrade of APP>

In a case where addition or upgrade of an APP changes a necessary resource quantity (increase in memory capacity, for example), the system manager changes the allocation control information 672. In a case where the allocation control information 672 is present on a tenant basis and the system manager gives each tenant manager authority to change the allocation control information 672, the tenant manager may change the allocation control information 672 corresponding to the tenant corresponding to the tenant manager.

In the present embodiment, an integrated LPAR cannot be created in some cases because necessary resources cannot be secured (S1911 in FIG. 19), as described above. An example of a process carried out in this case will be described below in detail.

In a case where the run book automation program 660 fails to create an integrated LPAR (in a case where at least one of exclusively allocated server resources and storage resources is insufficient), error information that is information containing information representing the resource type of the insufficient resource is outputted (displayed, for example) as a cause of the failure. An integrated LPAR creation instructing user (tenant manager or system manager, for example) looks at the outputted error information and can examine an action to be taken.

Specifically, for example, in a case where the server resources are insufficient, the error information may contain a set of the ID (name, for example) of the server 100 where the server resources are insufficient, the resource type of the insufficient server resource (CPU, memory, NIC port, and HBA port, for example), and the resource quantity of the insufficient server resource. On the other hand, in a case where the storage resources are insufficient, for example, the error information may contain a set of the resource type of the insufficient storage resource (storage CPU, HBA port, CLPR, and VOL, for example) out of the storage resources coupled to the selected server resources and the resource quantity of the insufficient server resource. The error information may be outputted in the form of screen display or in the form of a log.

Since the run book automation program 660 checks whether or not resources have been secured for each of the servers 100 in the server resource selection process, the run book automation program 660, for example, stores a result of the checking in the storage section 630 and displays error information containing information representing the result of the checking when integrated LPAR creation fails. The error information may contain information representing an unsecured server resource on a server basis (may contain all results of the checking), or insufficient server resource information (resource type and resource quantity, for example) may be classified on a failure cause (insufficient memory, for example) basis. In a case where there are a plurality of unsecured resources due to the same failure cause, the error information may contain only information on one or more servers where a large number of resources have been secured (at least server where largest number of resources have been secured).

Specific examples of the error information will be described below.

<Case where Cause of Failure is Insufficient Server Resource>

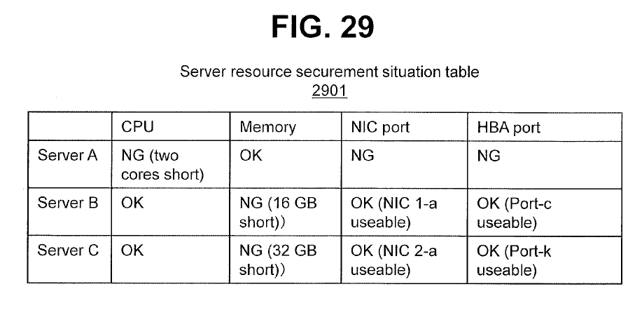

In the server resource selection process, in a case where the server resources are insufficient in each of the servers 100, the resource selection function 191 displays error information containing a server resource securement situation table 2901 shown in FIG. 29. According to the example in FIG. 29, the CPUs, the NIC ports, and the HBA ports are insufficient in the server A, and the memories are insufficient in the servers B and C. The following two actions are conceivable as actions that should be taken by an instruction issuing user who has looked at the error information:

(Action 1: Changing LPAR Size)

In a case where the integrated LPAR size has been configured at a relatively large value (in the case where size=M, for example), the instruction issuing user reduces the integrated LPAR size (to size=S, for example) and issues the integrated LPAR creation instruction again.

(Action 2: Solving Insufficient Server Resource)

The instruction issuing user increases the resource quantity of the insufficient server resource type indicated by the server resource securement situation table 2901 shown in FIG. 29 by the insufficient resource quantity indicated by the table 2901 or larger. To increase the server resource quantity, for example, hardware relating to the server 100 (server HBA, for example) is added, or an existing LPAR (existing server LPAR or integrated LPAR, for example) is deleted to release the server resources exclusively allocated to the existing LPAR. After the insufficient server resource is solved, the instruction issuing user issues the integrated LPAR creation instruction again.

In the case of Action 2, even after the insufficient server resource is solved, it is not guaranteed that sufficient storage resources are secured. In this case, even when the insufficient server resource is solved, necessary storage resources cannot be secured, and it is likely that the insufficient server resource has been solved (server resource has been added) in vain. To avoid the situation, the run book automation program 660 accepts specification of the server where the insufficient server resource has been solved from the instruction issuing user and runs a simulation to see whether or not sufficient storage resources can be secured for the specified server on the assumption that the insufficient server resource has been solved in the server (that is, the same processes as those in S2003 and S2004 in FIG. 20 are carried out in the form of a simulation). The run book automation program 660 displays a result of the simulation. In a case where the result of the simulation shows that sufficient storage resources will be successfully secured (that is, in a case where the insufficient server resource has been solved and it is ascertained that sufficient storage resources will be secured), the instruction issuing user can solve the insufficient server resource in the specified server with no worry. In the simulation, the storage resource selection WF may be executed on the assumption that an input has been made in the resource selection process and insufficient server resource has been solved.

<Case where Cause of Failure is Insufficient Storage Resource>

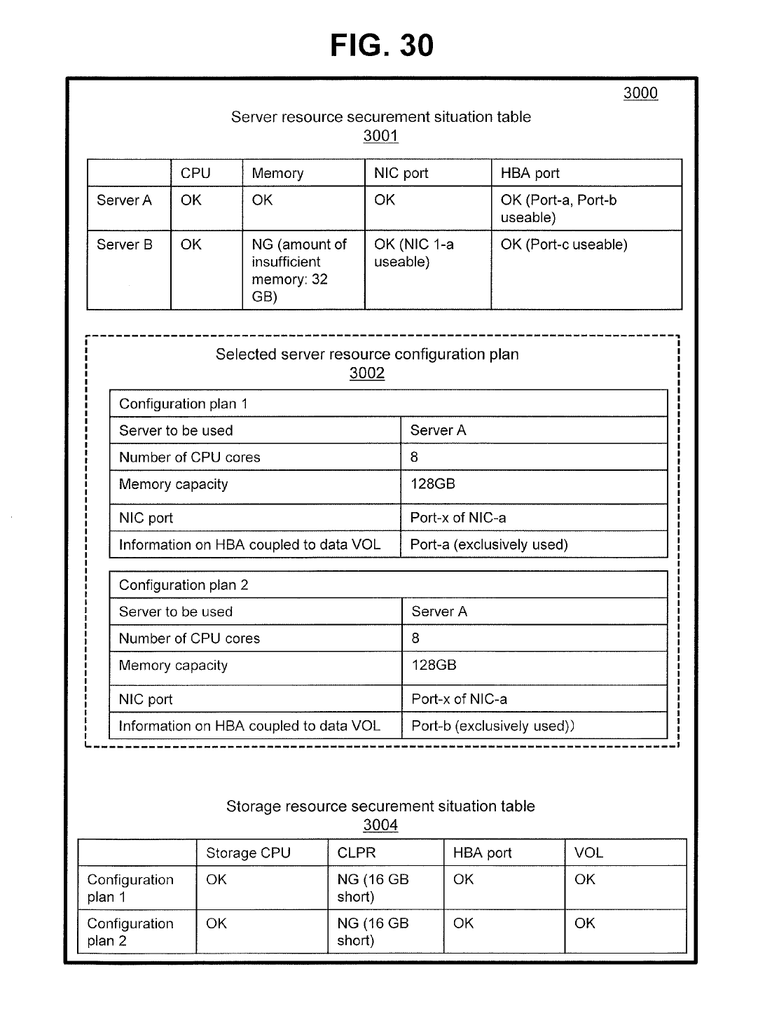

FIG. 30 shows an example of the error information outputted (displayed, for example) by the run book automation program 660 in a case where the cause of the failure is insufficient storage resources.

Error information 3000 contains a server resource securement situation table 3001, a selected server resource configuration plan information 3002, and a storage resource securement situation table 3004.

The server resource securement situation table 3001 contains information representing necessary server resources found in a server (server shown in table 3001) where the necessary server resources (server resources that satisfy parameters acquired in S1801) are found.

The selected server resource configuration plan information 3002 represents detailed configuration plans (server resource combination configuration plans) employable by the servers where the necessary server resources are found.

The storage resource securement situation table 3004 represents the resource types of insufficient storage resource and the insufficient resource quantities thereof on a configuration plan basis.

The server resource securement situation table 3001 may contain information on a server resource combination (server) excluded from the candidates in the server resource selection process, that is, information on a server where the server resources are insufficient. The information may contain the same information as that displayed in the case where the cause of the failure is an insufficient server resource, that is, the resource type and the resource quantity of the insufficient server resource. The instruction issuing user can thus determine an action to be taken after evaluation of which is easier, solving the insufficient storage resource or solving the insufficient server resource.

The example in FIG. 30 shows that the memory in the server B is insufficient in the server resource selection process. The example in FIG. 30 further shows that CLPR is insufficient in the storage resource selection process in each of the configuration plans 1 and 2. The instruction issuing user who has looked at the results described above conceivably takes any of the following three actions:

(Action A: Changing Integrated LPAR Size)

In a case where the integrated LPAR size has been configured at a relatively large value (in the case where size=M, for example), the instruction issuing user reduces the integrated LPAR size (size=S, for example) and issues the integrated LPAR creation instruction again.

(Action B: Solving Insufficient Storage Resource)

The instruction issuing user increases the storage resource quantity of the insufficient storage resource type indicated by the storage resource securement situation table 3004 by the insufficient resource quantity indicated by the table 3004 or larger. To increase the storage resource quantity, for example, hardware relating to the storage 120 (storage HBA, for example) is added, or an existing integrated LPAR or an existing storage partition is deleted to release the storage resources exclusively allocated to the existing integrated LPAR or the existing storage partition. After the insufficient storage resource is solved, the instruction issuing user issues the integrated LPAR creation instruction again.

(Action C: Solving Insufficient Server Resource)

The instruction issuing user increases the resource quantity of the insufficient server resource type indicated by the server resource securement situation table 3001 by the insufficient resource quantity indicated by the table 3001 or larger. After the insufficient server resource is solved by the increasing operation described above, the instruction issuing user issues the integrated LPAR creation instruction again.

An embodiment has been described above. The embodiment is presented by way of example for describing the present invention, and it is not intended that the scope of the present invention is limited only to the embodiment. The present invention can be implemented in a variety of other forms. For example, in the embodiment described above, the characteristics of a load on an integrated LPAR are load characteristics (I/O characteristics, for example) expected (predicted) on the basis of an APP intended use and a VOL intended use. Instead, load characteristics (I/O characteristics, for example) obtained as actually measured values may be employed.

Further, the server storage system 1000 may be a system including servers 100 and storages 120 that play predetermined roles of a server and a storage (or storage controller) or a system which is formed of a plurality of computers (plurality of same computers, for example) that play undetermined roles and in which a manager's role configuration determines whether each of the computers plays the role of a server or the role of a storage (storage controller). In a case where each of the computers plays both the roles of a server and a storage, part of the resources of the computer is used as server resources and another part of the resources of the computer is used as storage resources.

According to the embodiment (FIG. 2A, for example), both in the logical division of the portion including the servers 100 and the storages 120 and the logical division based on at least one of the I/O characteristic, the APP intended use, and other factors (logical division of actual system, for example), a plurality of types of resource corresponding to a plurality of continuous tiers are logically divided (allocation control). In the logical division, however, the plurality of tiers are not necessarily continuous in a strict sense. For example, even when first and second resources are logically dividable resources, a third resource between the first and second resources in a tiered structure is a logically undividable resource in some cases. In this case, in the logical division of resources from an upper level to a lower level, a middle resource is not logically divided. It can, however, be said that such a case also substantially falls within logical division of resources from an upper level to a lower level (logical division of portion including servers 100 and storages 120, for example). Whether or not a resource is a logically dividable resource may depend on at least one of the type of the resource and the function of the storages 120.

### REFERENCE SIGNS LIST

100: Server, 120: Storage system

1. A management system that manages a server storage system including server systems and storage systems, the management system comprising:
an interface coupled to the server storage system;
a storage section configured to store allocation control information; and
a processor coupled to the interface and the storage section,
wherein the server storage system includes a plurality of resources including a plurality of types of resource,
the plurality of resources include a plurality of server resources including a plurality of types of server resource provided in the server systems and a plurality of storage resources including a plurality of types of storage resource provided in the storage systems,
the allocation control information is information representing a correspondence among resource types and resource quantities of exclusively allocated server resources and storage resources, resource types and resource quantities of commonly allocated server resources and storage resources, and virtual server load characteristics that are characteristics of a load on a virtual server,
the processor is configured to
(A) accept a virtual server creation instruction with which one or more types of load characteristic information are associated, the one or more types of load characteristic information being one or more types of information each relating to the virtual server load characteristics and inputted by a manager,
(B) select the exclusively allocated server resources and storage resources based on the allocation control information and the one or more types of load characteristic information, and
(C) allocate, when at least one of the server resources and the storage resources is selected in (B), the selected resource to the target virtual server, and
the allocation control information is changeable information.

2. The management system according to claim 1,
wherein the processor is configured to
(P) accept a new correspondence among the resource types and resource quantities of exclusively allocated server resources and storage resources, the resource types and resource quantities of commonly allocated server resources and storage resources, and the virtual server load characteristics, and
(Q) add the inputted new correspondence to the allocation control information.

3. The management system according to claim 1,
wherein the processor is configured to select in (B) both server resources and storage resources that satisfy a predetermined condition and then execute (C), and
the server resources and the storage resources that satisfy the predetermined condition are server resources and storage resources physically coupled to each other and having resource types and resource quantities based on the allocation control information and the one or more types of load characteristic information.

4. The management system according to claim 1,
wherein in a case where at least one of the exclusively allocated server resources and storage resources is insufficient, the processor is configured to
(X) output error information that is information containing information representing the resource type of the insufficient resource.

5. The management system according to claim 1,
wherein after (C) is completed, the processor is configured to
(D) automatically configure the target virtual server in such a way that the target virtual server is activated by using an activation image of the target virtual server.

6. The management system according to claim 5,
wherein each of (B) to (D) is executed by execution of one or more defined workflows,
at least one of the workflows is changeable,
the processor is configured not to permit a first manager to change at least one of the workflows but is configured to permit a second manager to permit the change,
the first manager is a manager who manages a virtual server but does not manage at least the server storage system, and
the second manager is a manager who manages at least the server storage system.

7. The management system according to claim 1,
wherein the processor is configured not to permit a first manager to change the allocation control information but is configured to permit a second manager to permit the change,
the first manager is a manager who manages a virtual server but does not manage at least the server storage system, and
the second manager is a manager who manages at least the server storage system.

8. The computer system according to claim 1,
wherein the server storage system includes a plurality of subsystems obtained by logically dividing a portion including the server systems and the storage systems,
a first subsystem out of the plurality of subsystems is an actual system that is a subsystem that belongs to an actual environment,
a second subsystem out of the plurality of subsystems is a development system that is a subsystem that belongs to a development environment, and
the one or more types of load characteristic information contains information representing whether a subsystem is the actual environment or the development environment, and
in the allocation control information, for the same at least one virtual server load characteristic, resource types and resource quantities corresponding to the actual system differ from resource types and resource quantities corresponding to the development system.

9. The management system according to claim 3,
wherein in a case where at least one of necessary server resources that are server resources having the resource types and the resource quantities based on the allocation control information and the one or more types of load characteristic information is insufficient in each of the server systems, the error information contains information representing the resource type and an insufficient resource quantity of the insufficient server resource on a server system basis, and
assuming that the insufficient server resource is solved, the processor is configured to search for a necessary storage resource that is associated with the server resource and is a storage resource having the resource type and the resource quantity based on the allocation control information and the one or more types of load characteristic information.

10. The management system according to claim 9,
wherein in a case where all the necessary server resources are present in at least one of the server systems, but at least one of the necessary storage resources is insufficient in each of the storage systems, the error information contains information representing the necessary server resources found in the server system where the necessary server resources are found and information representing the resource type and the insufficient resource quantity of the insufficient storage resource.

11. The management system according to claim 10,
wherein in a case where at least one of the necessary server resources is insufficient in any of the server systems, the error information further contains information representing the resource type and the insufficient resource quantity of the insufficient server resource.

12. The management system according to claim 6,
wherein following processes are carried out in (B): a parameter acquisition process that is a process of acquiring parameters corresponding to the one or more types of load characteristic information from the allocation control information; and a resource selection process that is a process of selecting server resources and storage resources relevant to the acquired parameter, and
a workflow for the parameter acquisition process is independent of a workflow for the resource selection process and is a changeable workflow.

13. The management system according to claim 1,
wherein the one or more pieces of load characteristic information contains APP identification information used to identify an APP executed by the target virtual server and an APP intended use of the APP.

14. The management system according to claim 13,
wherein the one or more pieces of load characteristic information further contains a virtual server size, and
in the allocation control information, for at least one of combinations of the same APP identification information and APP intended use, when the virtual server size varies, the resource quantity varies even when the resource type is the same.

15. A method for managing a server storage system including server systems and storage systems, the server storage system including a plurality of resources including a plurality of types of resource, and the plurality of resources including a plurality of server resources including a plurality of types of server resource provided in the server systems and a plurality of storage resources including a plurality of types of storage resource provided in the storage systems,
the management method including:
(A) accepting a virtual server creation instruction with which one or more types of load characteristic information are associated, the one or more types of load characteristic information being one or more types of information each relating to virtual server load characteristics and inputted by a manager,
(B) selecting exclusively allocated server resources and storage resources based not only on allocation control information that is information representing a correspondence among resource types and resource quantities of the exclusively allocated server resources and storage resources, resource types and resource quantities of commonly allocated server resources and storage resources, and virtual server load characteristics that are characteristics of a load on a virtual server but on the one or more types of load characteristic information, and
(C) allocating, when at least one of the server resources and the storage resources is selected in (B), the selected resource to the target virtual server,
wherein the allocation control information is changeable information.
